(19) United States
(12) Patent Application Publication
(10) Pub. No.: US 2026/0006687 A1
(43) Pub. Date: Jan. 1, 2026

(54) METHOD OF DETERMINING SUSCEPTOR CHANGE AND AEROSOL GENERATING DEVICE PERFORMING THE METHOD

(71) Applicant: KT&G CORPORATION, Daejeon (KR)

(72) Inventor: Sang Kyu PARK, Seoul (KR)

(73) Assignee: KT&G CORPORATION, Daejeon (KR)

(21) Appl. No.: 19/240,258

(22) Filed: Jun. 17, 2025

(30) Foreign Application Priority Data
Jun. 26, 2024 (KR) 10-2024-0083620

(51) Int. Cl. H05B 6/08; A24F 40/20; A24F 40/465; A24F 40/51; A24F 40/53; A24F 40/57; G01N 27/72; H05B 6/10

(52) U.S. Cl. CPC H05B 6/08; A24F 40/20; A24F 40/465; A24F 40/51; A24F 40/53; A24F 40/57; G01N 27/72; H05B 6/105; H05B 2213/05

(57) ABSTRACT

A method of determining whether a susceptor is changed, according to an embodiment, includes applying a first signal to a coil of a heater so that an alternating magnetic field having a first frequency is generated, determining a first value of an electrical characteristic of a susceptor indicated by the first signal, applying a second signal to the coil of the heater so that an alternating magnetic field having a second frequency is generated, determining a second value of an electrical characteristic of the susceptor indicated by the second signal, and determining whether the susceptor is a changed susceptor based on the first value and the second value.

### CROSS-REFERENCE TO RELATED APPLICATION

This application claims the benefit of Korean Patent Application No. 10-2024-0083620 filed on Jun. 26, 2024, in the Korean Intellectual Property Office, the entire disclosure of which is incorporated herein by reference for all purposes.

### BACKGROUND

### 1. Field of the Invention

The following embodiments relate to a technology for controlling an aerosol generating device, and more particularly, to a technology for controlling an aerosol generating device that heats an aerosol generating article using an inductive heating scheme.

### 2. Description of the Related Art

The demand for electronic cigarettes, or e-cigarettes, has recently been on the rise. The rising demand for e-cigarettes has accelerated the continued development of e-cigarette-related functions. The e-cigarette-related functions may include, for example, functions according to the types and characteristics of e-cigarettes.

Typically, to heat a cigarette using an inductive heating scheme, an e-cigarette may use a coil to generate an alternating magnetic field to generate eddy currents in a susceptor adjacent to the cigarette. The temperature of the susceptor may increase due to eddy currents generated in the susceptor.

### SUMMARY

An embodiment may provide an aerosol generating device that determines whether a susceptor located within the aerosol generating device is a different susceptor than a previous susceptor.

An embodiment may provide an aerosol generating device in which a signal applied to a coil of a heater is controlled by obtaining a control characteristic of a susceptor located within the aerosol generating device.

However, technical goals are not limited to the technical goals described above, and other technical goals may exist.

According to an aspect, there is provided a method of determining a susceptor change, including applying a first signal to a coil of a heater so that an alternating magnetic field having a first frequency is generated, determining a first value of an electrical characteristic of a susceptor indicated by the first signal, applying a second signal to the coil of the heater so that an alternating magnetic field having a second frequency is generated, determining a second value of an electrical characteristic of the susceptor indicated by the second signal, and determining whether the susceptor is a changed susceptor based on the first value and the second value.

According to another aspect, there is provided an aerosol generating device including a coil configured to generate an alternating magnetic field and a controller configured to control the aerosol generating device, wherein the controller may apply a first signal to the coil of the heater so that an alternating magnetic field having a first frequency is generated, determine a first value of an electrical characteristic of a susceptor indicated by the first signal, apply a second signal to the coil of the heater so that an alternating magnetic field having a second frequency is generated, determine a second value of an electrical characteristic of the susceptor indicated by the second signal, and determine whether the susceptor is a changed susceptor based on the first value and the second value.

Additional aspects of embodiments will be set forth in part in the description which follows and, in part, will be apparent from the description, or may be learned by practice of the disclosure.

According to at least one of the embodiments of the present disclosure, an aerosol generating device that obtains electrical characteristics of a susceptor coupled to the aerosol generating device to determine whether the susceptor has been changed may be provided.

According to at least one of the embodiments of the present disclosure, an aerosol generating device in which a signal applied to a coil of a heater is controlled based on a control characteristic of a new susceptor when a susceptor coupled to the aerosol generating device is a new susceptor different from a previous susceptor may be provided.

### BRIEF DESCRIPTION OF THE DRAWINGS

These and/or other aspects, features, and advantages of the present disclosure will become apparent and more readily appreciated from the following description of embodiments, taken in conjunction with the accompanying drawings of which:

FIG. 1 is a diagram illustrating an aerosol generating device according to an embodiment of the present disclosure;

FIG. 2 is a diagram illustrating an aerosol generating device according to another embodiment of the present disclosure;

FIG. 3 is a diagram illustrating an aerosol generating device according to another embodiment of the present disclosure;

FIG. 4 is a front perspective view illustrating an aerosol generating device according to embodiments of the present disclosure;

FIG. 5 is an exploded cross-sectional view illustrating an upper case and a body of an aerosol generating device according to an embodiment of the present disclosure;

FIG. 6 is an exploded cross-sectional view illustrating an upper case, a body, and a heater holder of an aerosol generating device according to an embodiment of the present disclosure;

FIG. 7 is a cross-sectional view illustrating an upper case, a body, and a heater holder of an aerosol generating device according to an embodiment of the present disclosure;

FIG. 8 is a cross-sectional view illustrating a heater holder of an aerosol generating device according to an embodiment of the present disclosure;

FIG. 9 is a block diagram of an aerosol generating device according to an embodiment of the present disclosure;

FIG. 10 is a flowchart of a method of determining whether a susceptor is a changed susceptor, according to an embodiment of the present disclosure;

FIG. 11 is a diagram illustrating trajectories of eddy currents in a susceptor as indicated by a frequency of a signal, according to an embodiment of the present disclosure;

FIG. 12 is a flowchart of a method of obtaining a control characteristic of a susceptor according to an embodiment of the present disclosure;

FIG. 13 is a flowchart of a method of determining whether a susceptor is a changed susceptor at a target point in time in a first temperature profile, according to an embodiment of the present disclosure;

FIG. 14 is a diagram illustrating a first temperature profile and a target point in time, according to an embodiment of the present disclosure;

FIG. 15 is a diagram illustrating a signal applied to a coil of a heater based on a first temperature profile, according to an embodiment of the present disclosure;

FIG. 16 is a flowchart of a method of controlling a signal applied to a coil of a heater, according to an embodiment of the present disclosure;

FIG. 17 is a flowchart of a method of controlling a signal applied to a coil of a heater, according to an embodiment of the present disclosure;

FIG. 18 is a diagram illustrating power and threshold power consumed by a coil of a heater, according to an embodiment of the present disclosure;

FIG. 19 is a flowchart of a method of obtaining a control characteristic of a susceptor, according to an embodiment of the present disclosure; and

FIG. 20 is a diagram illustrating a temperature change of a susceptor when a calibration signal is applied, according to an embodiment of the present disclosure.

### DETAILED DESCRIPTION

Hereinafter, embodiments will be described in detail with reference to the accompanying drawings. When describing the embodiments with reference to the accompanying drawings, like reference numerals refer to like components and a repeated description related thereto will be omitted.

The suffix “module” and “unit”, “part”, or “portion” for components used in the following description are given or interchangeably used only in terms of ease of description, and do not have meanings or roles that are distinguished from each other.

Further, in the following description of the embodiments disclosed herein, a detailed description of known related technologies may be omitted to avoid obscuring the subject matter of the embodiments disclosed herein. The embodiments disclosed in the present specification and the drawings are intended merely to present specific examples in order to aid in understanding of the present disclosure, but are not intended to limit the scope of the present disclosure. Here, the embodiments should be understood to include all changes, equivalents, and replacements within the idea and the technical scope of the disclosure.

Although terms of “first,” “second,” and the like are used to explain various components, the components are not limited to such terms. These terms are used only to distinguish one component from another component.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween.

As used herein, the singular forms “a,” “an,” and “the” are intended to include the plural forms as well, unless the context clearly indicates otherwise.

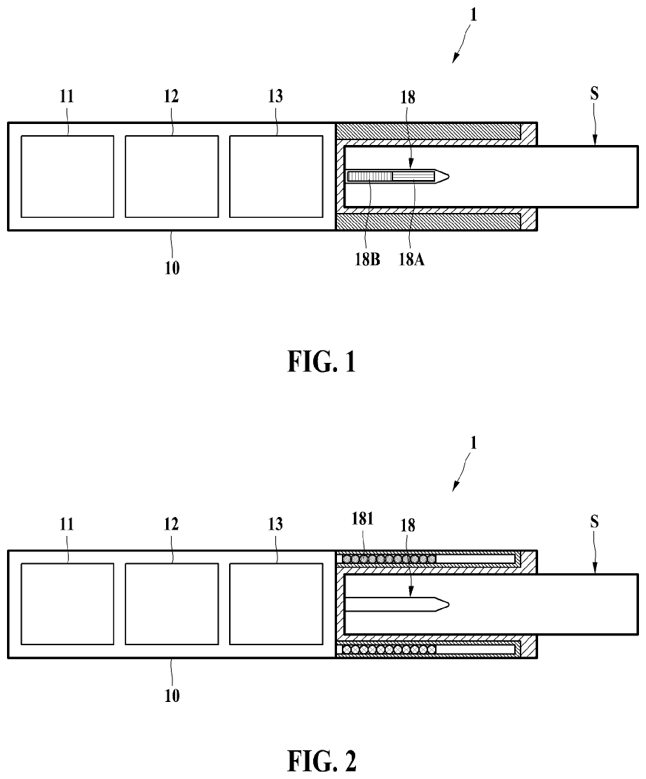

FIGS. 1 to 3 are diagrams illustrating an aerosol generating device according to various embodiments of the present disclosure.

Referring to FIG. 1, an aerosol generating device 1 according to embodiments of the present disclosure may include at least one of a power source 11, a controller 12, a sensor 13, and a heater 18. At least one of the power source 11, controller 12, sensor 13, and heater 18 may be disposed inside of a body 10 of the aerosol generating device 1. The body 10 may provide a space opened upward so that a stick S, which is an aerosol generating article, may be inserted. The space opened upward may be referred to as an insertion space. The insertion space may be recessed by a predetermined depth toward the inside of the body 10 so that at least a portion of the stick S may be inserted therein. The depth of the insertion space may correspond to a length of an area in the stick S which includes an aerosol generating material and/or medium. A lower end of the stick S may be inserted into the body 10, and an upper end of the stick S may protrude to the outside of the body 10. A user may inhale air by holding in their mouth the upper end of the stick S exposed to the outside.

The heater 18 may heat the stick S. The heater 18 may be elongated upward in a space in which the stick S is inserted. The heater 18 may include, for example, a tubular heating element, a plate-type heating element, a needle-type heating element, or a rod-type heating element. The heater 18 may be inserted into a lower portion of the stick S. The heater 18 may include an electric resistance heater and/or an induction heater.

Referring to FIG. 1, the heater 18 may be, for example, a resistance heater. For example, the heater 18 may include an electrically conductive track and may be heated as current flows through the electrically conductive track. The heater 18 may be electrically connected to the power source 11. The heater 18 may be directly heated by receiving current from the power source 11.

For example, the heater 18 may be a multi-heater. The heater 18 may include a first heater 18A and a second heater 18B. The first and second heaters 18A and 18B may be disposed in parallel along a longitudinal direction. The first and second heaters 18A and 18B may be sequentially heated or simultaneously heated.

Referring to FIG. 2, the aerosol generating device 1 may include, for example, an induction coil 181 surrounding the heater 18. The induction coil 181 may generate heat in the heater 18. The heater 18, as a susceptor, may generate heat by a magnetic field generated by an AC current flowing through the induction coil 181. The magnetic field may penetrate the heater 18 and generate eddy currents within the heater 18. The currents may generate heat in the heater 18.

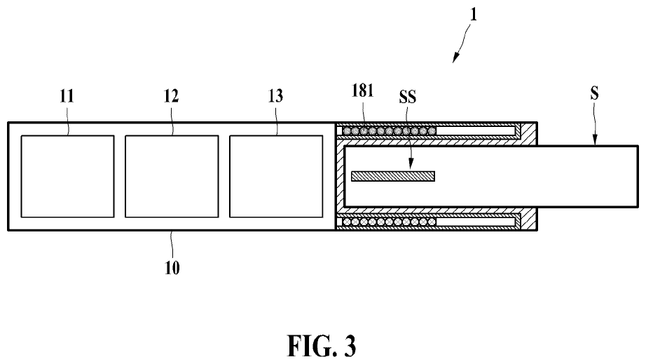

Referring to FIG. 3, for example, a susceptor SS may be included inside of the stick S, and the susceptor SS disposed inside the stick S may generate heat by the magnetic field generated by the AC current flowing through the induction coil 181. The susceptor SS may be disposed inside the stick S and may not be electrically connected to the aerosol generating device 1. The susceptor SS may be inserted into the insertion space together with the stick S and removed from the insertion space together with the stick S. The stick S may be heated by the susceptor SS disposed inside the stick S. In this case, the aerosol generating device 1 may not be provided with the heater 18.

The power source 11 may supply power such that the components of the aerosol generating device 1 may operate. The power source 11 may be referred to as a battery. The power source 11 may supply power to at least one of the controller 12, the sensor 13, or the heater 18. The power source 11 may supply power to the induction coil 181.

The controller 12 may control the overall operation of the aerosol generating device 1. The controller 12 may be mounted on a printed circuit board (PCB). The controller 12 may control an operation of at least one of the power source 11, the sensor 13, or the heater 18. The controller 12 may control an operation of the induction coil 181. The controller 12 may control the operations of a display, a motor, or the like installed in the aerosol generating device 1. The controller 12 may examine a state of each component of the aerosol generating device 1 to determine whether the aerosol generating device 1 is in an operable state.

The controller 12 may analyze a result detected by the sensor 13 and control the processes to be performed thereafter. For example, based on the result detected by the sensor 13, the controller 12 may control the power supplied to the heater 18 to start or end an operation of the heater 18. For example, based on the result detected by the sensor 13, the controller 12 may control the amount of power supplied to the heater 18 and a duration for which the power is supplied such that the heater 18 may be heated to a preset temperature or maintain an appropriate temperature.

The sensor 13 may include at least one of a temperature sensor, a puff sensor, an insertion detection sensor, or an acceleration sensor. For example, the sensor 13 may sense at least one of a temperature of the heater 18, a temperature of the power source 11, or a temperature inside and outside the body 10. For example, the sensor 13 may sense a user's puff. For example, the sensor 13 may sense whether the stick S is inserted into the insertion space. For example, the sensor 13 may sense a motion of the aerosol generating device 1.

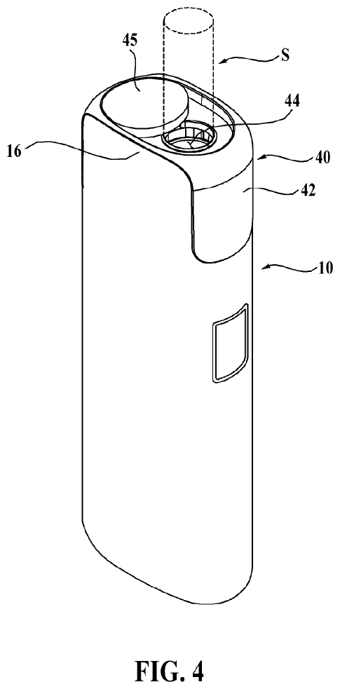

FIG. 4 is a front perspective view illustrating an aerosol generating device according to embodiments of the present disclosure.

Referring to FIG. 4, an upper case 40 of an aerosol generating device (e.g., the aerosol generating device 1 of FIGS. 1 to 3) may be detachably coupled to the body 10. The upper case 40 may be coupled to the upper side of the body 10. The upper case 40 may cover the upper periphery of the body 10. The upper case 40 may include an insertion hole 44. The stick S may be inserted into the insertion hole 44. The upper case 40 may include a cap 45 that opens and closes the insertion hole 44. The cap 45 may slide in a lateral direction to open and close the insertion hole 44.

The upper case 40 may include an upper case wing 42. The upper case wing 42 may extend downward from both sides of a upper case body. The upper case wing 42 may be referred to as the upper case grip 42.

The body 10 may include a body wing 16. The body wing 16 may extend upward from an edge of an upper portion of the body 10. The body wings 16 may be formed as a pair facing each other with the upper portion of the body 10 as the center. The body wing 16 may be formed at a position deviated from the upper case wing 42.

When the upper case 40 is coupled to the body 10, the upper case 40 may form an upper appearance of the aerosol generating device. When the upper case 40 is coupled to the body 10, the body wing 16 may cover a side portion of the upper case 40 exposed between the upper case wings 42. When the upper case 40 is coupled to the body 10, the upper case wing 42 may cover an outer wall of the body 10.

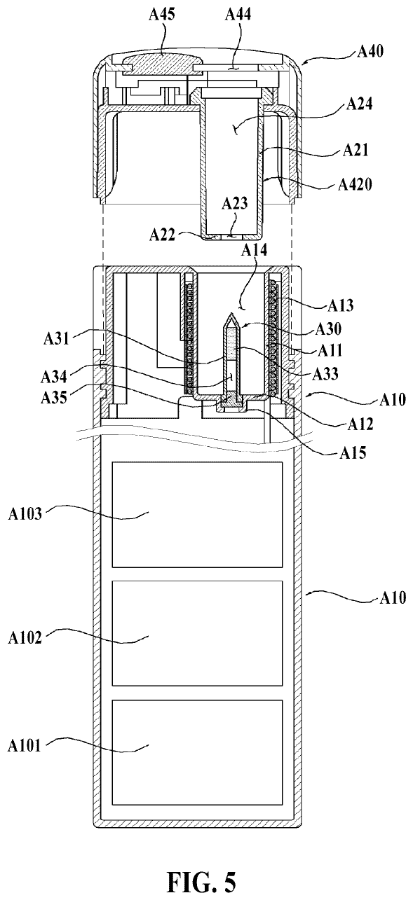

FIG. 5 is an exploded cross-sectional view illustrating an upper case and a body of an aerosol generating device according to an embodiment of the present disclosure.

Referring to FIG. 5, an aerosol generating device according to an embodiment of the present disclosure may include at least one of a battery A101, a controller A102, and a sensor A103. The at least one of the battery A101, controller A102, and sensor A103 may be disposed inside of a body A10 of the aerosol generating device. The features of the battery Al01, controller A102, and sensor A103 may be applied in the same manner as those of the battery 101, the controller 102, and the sensor 103 previously described above with reference to FIGS. 1 and 2.

The body A10 may include a pipe forming a first insertion space A14. The first insertion space A14 may be formed in an upper portion of the body A10. The first insertion space A14 may be opened upward. The first insertion space A14 may have a cylindrical shape extending vertically. A first lateral wall A11 of the pipe may surround a side portion of the first insertion space A14. A first flange A12 of the pipe may cover a lower portion of the first insertion space A14.

An extractor A420 may be provided with a second insertion space A24 therein. The second insertion space A24 may be opened toward the upper side of the extractor A420. The second insertion space A24 may have a cylindrical shape extending vertically. A second lateral wall A21 of the extractor A420 may surround a side portion of the second insertion space A24. A second flange A22 of the extractor A420 may cover a lower portion of the second insertion space A24. A through hole A23 may be formed by the center of the second flange A22 being opened.

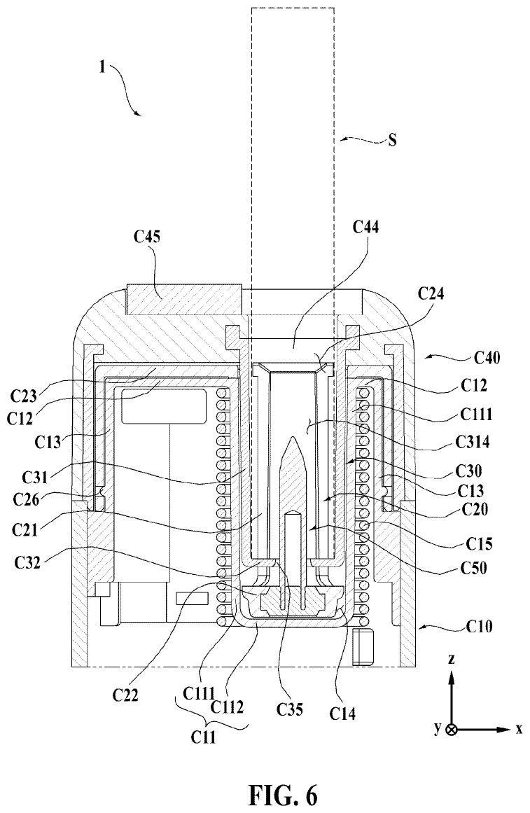

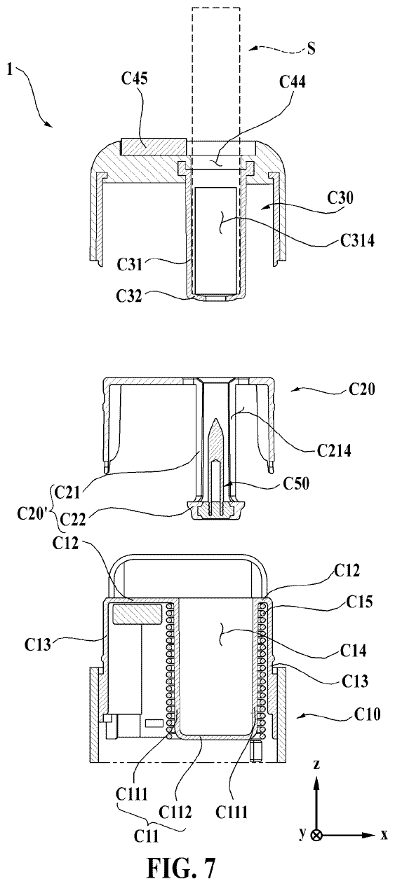

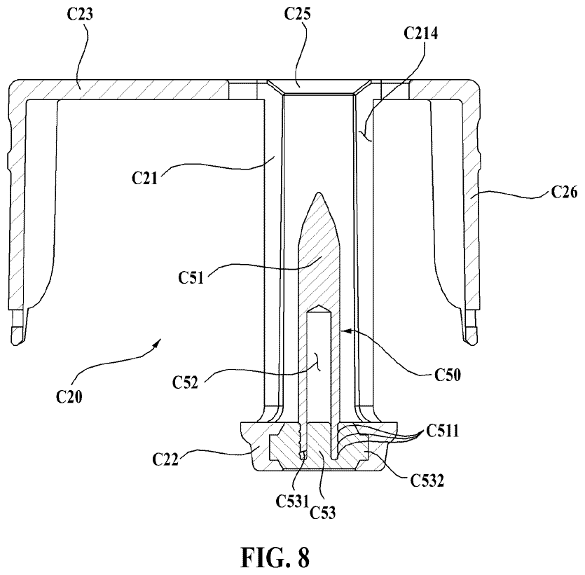

FIG. 6 is an exploded cross-sectional view illustrating an upper case C40 (e.g., the upper case 40), a body C10 (e.g., the body 10), and a heater holder C20 of the aerosol generating device 1 according to an embodiment of the present disclosure, FIG. 7 is a cross-sectional view illustrating the upper case C40, body C10, and heater holder C20 of the aerosol generating device 1 according to an embodiment of the present disclosure, and FIG. 8 is a cross-sectional view illustrating the heater holder C20 of the aerosol generating device 1 according to an embodiment of the present disclosure.

Referring to FIGS. 6 and 7, the body C10 may have a shape extending vertically. The body C10 may provide a first insertion space C14 therein. The first insertion space C14 may be opened upward. The first insertion space C14 may have a cylindrical shape extending vertically. The first insertion space C14 may be defined by a body pipe C11 formed inside the body C10. The body pipe C11 may include a lateral wall C111 surrounding the circumference of the first insertion space C14 and a bottom wall C112 covering the bottom of the first insertion space C14.

The heater holder C20 and an extractor C30 may be detachably inserted into the first insertion space C14. A pipe C20′ may include a lateral wall C21 that extends vertically and a bottom wall C22 formed at a lower end of the lateral wall C21. The bottom wall C22 of the pipe C20′ may be referred to as the bottom or the mount. The bottom wall C22 of the pipe C20′ may form the bottom of the heater holder C20. A heater C50 (e.g., the heater 18) may be coupled to or fixed to the heater holder C20.

The lateral wall C21 of the heater holder C20 and a lateral wall C31 of the extractor C30 together may define a second insertion space C24 that is opened upward. Each of the lateral wall C21 of the heater holder C20 and the lateral wall C31 of the extractor C30 may cover at least a side of the second insertion space C24. The lateral wall C21 of the heater holder C20 and the lateral wall C31 of the extractor C30 together may form a side perimeter of the second insertion space C24.

The lateral wall C31 of the extractor C30 may be extended vertically. Each of the lateral wall C21 of the heater holder C20 and the lateral wall C31 of the extractor C30 may be spaced apart from the center of the second insertion space C24 by the same distance, based on a radial direction. Each of the lateral wall C21 of the heater holder C20 and the lateral wall C31 of the extractor C30 may be positioned on the same circumference extension line of the second insertion space C24. Each of the lateral wall C21 of the heater holder C20 and the lateral wall C31 of the extractor C30 may be curved and extended in a circumferential direction along the circumference of the second insertion space C24.

A plurality of the lateral walls C21 of the heater holder C20 may be arranged along the circumference of the bottom wall C22 of the heater holder C20. A first slit C214 extending vertically may be formed between each of the plurality of the lateral walls C21 of the heater holder C20. The plurality of the lateral walls C21 of the heater holder C20 and the plurality of the first slits C214 may be arranged alternately in a circumferential direction along the circumference of the second insertion space C24.

A plurality of the lateral walls C31 of the extractor C30 may be arranged along the circumference of a bottom wallC32 of the extractor C30. A second slit C314 extending vertically may be formed between each of the plurality of the lateral walls C31 of the extractor C30. The plurality of the lateral walls C31 of the extractor C30 and the plurality of the second slits C314 may be arranged alternately in a circumferential direction along the circumference of the second insertion space C24.

The extractor C30 may be inserted into the heater holder C20. When the extractor C30 is inserted into the heater holder C20, the lateral wall C21 of the heater holder C20 may be disposed in the second slit C314, and the lateral wall C31 of the extractor C30 may be disposed in the first slit C214.

Accordingly, the lateral wall C21 of the heater holder C20 and the lateral wall C31 of the extractor C30 may form the second insertion space C24. In addition, by reducing the thickness of a wall between an induction coil C15 (e.g., the induction coil 181) and the heater C50, the heat generation efficiency of the heater C50 may be improved.

A lower end of the stick S may be inserted into the second insertion space C24, and an upper end of the stick S may protrude outside the aerosol generating device 1. The heater C50 may heat the first insertion space C14 and the second insertion space C24. The heater C50 may heat the stick S inserted into the second insertion space C24.

A lower end of the heater C50 may be fixed to the bottom wall C22 of the pipe C20′. The heater C50 may be elongated towards an opening of the second insertion space C24. For example, the heater C50 may be formed in a cylindrical shape and may include an upper end pointed upward. In another example, the heater C50 may have a shape extending in a circumferential direction and may be coupled to the lateral wall C21 of the heater holder C20. However, this is only an example, and the shape of the heater C50 is not limited to that described above or illustrated, and may be any shape capable of heating the stick S inserted into the second insertion space C24 by being coupled to the heater holder C20. The heater holder C20 may be formed by insert injection molding into the heater C50.

A through hole C35 may be formed by opening the bottom wall C32 of the extractor C30. The through hole C35 may be opened vertically. When the extractor C30 is inserted into the heater holder C20, the heater C50 may protrude through the through hole C35 into the second insertion space C24. When the stick S is inserted into the second insertion space C24, the heater C50 may be inserted into a lower portion of the stick S.

The induction coil C15 may surround the first insertion space C14. The induction coil C15 may be wound around the lateral wall C111 of the body pipe C11. For example, the induction coil C15 may generate heat in the heater C50. In another example, the heater C50 may be electrically connected directly to a power supply source through a terminal formed in the heater holder C20 and may be supplied with power to generate heat.

Accordingly, the heater C50 may be easily replaced. The sizes of the insertion spaces C14 and C24 and the heater C50 disposed in the insertion spaces C14 and C24 may be very small and may be difficult to replace, but a user may easily replace the heater C50 by separating the heater holder C20 from the aerosol generating device 1 and placing a new heater holder C20 in the aerosol generating device 1.

Additionally, the stick S may be easily separated from the heater C50. The user may easily separate the stick S from the heater C50 by separating the extractor C30 and the heater holder C20 from each other. The stick S inserted into the extractor C30 may be separated more easily from the extractor C30 by being separated from the heater C50. The stick S may be separated even when the extractor C30 and the heater holder C20 are not separated from each other.

In addition, foreign substances generated from the stick S may be extracted through the extractor C30 without remaining around the heater C50 and the heater holder C20.

Accordingly, cleaning of the aerosol generating device 1 around the heater C50 may become easier, and convenience of management may be improved. In addition, factors that may reduce the performance of the heater C50 may be reduced, the durability of the heater C50 may be improved, and a replacement cycle of the heater C50 may be extended. In addition, factors that may alter the taste of the stick S may be reduced.

The heater holder C20 may be disposed between the body C10 and the extractor C30.

The lateral wall C111 of the body pipe C11 may surround the lateral wall C21 of the heater holder C20 and the lateral wall C31 of the extractor C30. The bottom wall C112 of the body pipe C11 may face the bottom wall C22 of the heater holder C20. The bottom wall C22 of the heater holder C20 may face the bottom wall C32 of the extractor C30.

The bottom wall C32 of the extractor C30 may be spaced upward from the bottom wall C22 of the heater holder C20. Air may flow between the extractor C30 and the heater holder C20, pass through the through hole C35, and be provided to the stick S inserted into the second insertion space C24.

The top wall C12 of the body C10 may extend outward along a horizontal direction from an upper end of the body pipe C11. An outer lateral wall C13 of the body C10 may extend downward from an outer end of the top wall C12 of the body C10. The induction coil C15 may be disposed between the body pipe C11 and the outer lateral wall C13 of the body C10.

The upper case C40 may be detachably coupled to the body C10. The upper case C40 may be coupled to the upper side of the body C10. The upper case C40 may cover the periphery of the first insertion space C14 and the upper periphery of the body C10. The upper case C40 may be provided with an insertion hole C44 (e.g., the insertion hole 44). The stick S may be inserted into the insertion hole C44. The upper case C40 may include a cap C45 (e.g., the cap 45) that opens and closes the insertion hole C44. The cap C45 may slide in a lateral direction to open and close the insertion hole C44. The heater holder C20 may be disposed between the body C10 and the upper case C40.

The extractor C30 may be coupled to the upper case C40. The upper end of the extractor C30 may be coupled to the upper case C40, and the lower end of the extractor C30 may protrude toward the lower side of the upper case C40. The extractor C30 may be coupled to a position corresponding to the insertion hole C44. The insertion hole C44 may be located on the upper side of the second insertion space C24. The insertion hole C44 may allow the second insertion space C24 to communicate with the outside of the aerosol generating device 1.

When the upper case C40 is coupled to the body C10, the upper case C40 may form the upper exterior of the aerosol generating device 1.

Accordingly, the user may more easily separate the extractor C30 from the body C10. The user may separate the extractor C30 without the inconvenience of gripping the extractor C30 inserted into the second insertion space C24 by holding the exterior of the upper case C40 and separating the upper case C40 from the body C10.

The heater holder C20 may include an extension portion C23. The extension portion C23 may be formed at an upper end of the heater holder C20. The extension portion C23 may extend outward in a horizontal direction from an upper end of the pipe C20′. The extension portion C23 may be referred to as a heater holder extension portion.

The heater holder C20 may include a heater holder wing C26. The heater holder wing C26 may extend downward from both ends of the extension portion C23.

The extension portion C23 may have a shape corresponding to the top wall C12 of the body C10. The heater holder wing C26 may have a shape corresponding to the outer lateral wall C13 of the body C10. When the pipe C20′ is inserted into the first insertion space C14, the extension portion C23 may be supported or seated on the top wall C12 of the body C10, and the heater holder wing C26 may face or be in contact with the outer lateral wall C13 of the body C10.

The top wall C12 of the body C10 may support the extension portion C23, and the extension portion C23 may support the pipe C20′. The pipe C20′ may be hung from the extension portion C23 and spaced upward from the bottom wall C112 of the body pipe C11 to form an air gap. The lateral wall C21 of the pipe C20′ and the lateral wall C31 of the extractor C30 may be spaced inward from the lateral wall C111 of the body pipe C11 to form an air gap.

The extension portion C23 may have a shape corresponding to the bottom surface of the upper case C40. When the upper case C40 is coupled to the body C10 and the extractor C30 is inserted into the pipe C20′, the extension portion C23 may be in contact with the bottom surface of the upper case C40.

A coupling member may be provided in each of the upper case C40, the extension portion C23, and the body C10. Each coupling member may be provided within the upper case C40, the extension portion C23, and the body C10 such that the upper case C40, the extension portion C23, and the body C10 are adjacent to each other while being coupled to each other. The heater holder C20 may be detachably coupled to the upper case C40 and/or the extractor C30 by each coupling member. For example, each coupling member may include at least one of a protrusion and a corresponding groove. However, each coupling member is not limited thereto, and any configuration that allows the heater holder C20 to be detachably coupled to the upper case C40 and/or the extractor C30 is possible.

Accordingly, the user may selectively couple the heater holder C20 to either a side of the body C10 or the extractor (C30) while separating the upper case C40 and/or the extractor C30 from the body C10. In addition, the upper case C40 and/or the extractor C30 may be more easily and stably coupled to the body C10.

The lateral wall C21 of the pipe C20′ and the lateral wall C31 of the extractor C30 may be spaced inward from the lateral wall C111 of the body pipe C11 to form an air gap. The heater C50 may be surrounded by the extractor C30 and the pipe C20′.

Accordingly, the amount of heat generated from the heater C50 and transferred to the body pipe C11 through the pipe C20′ and the extractor C30 may be reduced, thereby reducing the overheating of the aerosol generating device 1.

The upper case C40 may be separated from the body C10. The heater holder C20 may be detachably coupled to the upper case C40. The heater holder C20 may be detachably coupled to the upper case C40 by a scheme of coupling by magnetic attraction, a screw coupling scheme, a snap-fit coupling scheme, or the like.

When the upper case C40 is separated from the body C10, the heater holder C20 may be separated from the body C10 together with the upper case C40 while being coupled to the upper case C40. When the upper case C40 to which the heater holder C20 is coupled is separated from the body C10, the heater holder C20 may be separated from the upper case C40.

As another example, the heater holder C20 may be detachably coupled to the extractor C30. When the extractor C30 is separated from the body C10, the heater holder C20 may be separated from the body C10 together with the extractor C30 while being coupled to the extractor C30. When the extractor C30 to which the heater holder C20 is coupled is separated from the body C10, the heater holder C20 may be separated from the extractor C30.

The heater holder C20 coupled to the upper case C40 may protrude downward from the upper case C40. Accordingly, the heater holder C20 may be easily separated from the upper case C40 while being stably coupled to the upper case C40. In addition, the heater C50 may be conveniently replaced.

The heater holder C20 may be detachably coupled to the body C10. In a state in which the heater holder C20 is coupled to the body C10, the upper case C40 and/or the extractor C30 may be separated from the body C10 and the heater holder C20. In a state in which the upper case C40 and/or the extractor C30 are separated from the body C10 and the heater holder C20, the heater holder C20 may be separated from the body C10. The heater holder C20 may be detachably connected to the body C10 by a scheme of coupling by magnetic attraction, a screw coupling scheme, a snap-fit coupling scheme, or the like.

The extension portion C23 coupled to the body C10 may be exposed upward from the body C10. The heater holder wing C26 coupled to the body C10 may be exposed in a lateral direction from the body C10. Accordingly, the user may easily hold the heater holder C20.

Accordingly, the heater holder C20 may be easily separated from the body C10 while being stably coupled to the body C10. In addition, the user may conveniently replace the heater C50.

In addition, the user may easily separate the stick S from the heater C50. The user may easily separate the stick S from the heater C50 by separating the extractor C30 and the heater holder C20 from each other. The stick S inserted into the extractor C30 may be separated from the heater C50 and thus may be separated more easily from the extractor C30.

Referring to FIG. 8, a guide portion C25 may be formed on an inner circumferential surface of an upper end of the pipe C20′. The guide portion C25 may be disposed between the pipe C20′ and the extension portion C23. The guide portion C25 may extend to be inclined downward.

Accordingly, the guide portion C25 may contact a lower portion of the extractor C30 to guide the extractor C30 to be easily inserted into the heater holder C20.

A lower end of the heater C50 may be inserted and fixed into the mount (the bottom wall C22). The heater C50 may include a heater rod C51. The heater rod C51 may be extended vertically. The heater rod C51 may have a cylindrical shape. The heater rod C51 may include a cavity C52 that is opened downward. The cavity C52 may be extended vertically. The cavity C52 inside the heater rod C51 may be formed in a cylindrical shape.

The upper end of the heater rod C51 may be formed to be pointed upward.

The heater rod C51 may be formed of a resistive metal.

The heater C50 may include a support C53. The support C53 may be disposed on a lower side of the heater rod C51. The support C53 may be fixed to the heater rod C51. The support C53 may support a lower portion of the heater rod C51. The support C53 may fill a lower portion of the cavity C52. A side surface of the support C53 may be supported by the mount (the bottom wall C22). The support C53 may have high heat resistance. The support C53 may not be thermally deformed by heat generated from the heater rod C51.

The lower end of the heater rod C51 may be inserted into the support C53. A fitting groove C531 opened upward may be formed in the support C53. The fitting groove C531 may extend in a circumferential direction and have a ring shape. The lower end of the heater rod C51 may be inserted into and fitted into the fitting groove C531.

The heater rod C51 may be coupled to the support C53. A protrusion C511 may protrude outward from an outer circumferential surface of a lower end of the heater rod C51. A plurality of the protrusions C511 may be arranged spaced apart from each other along the outer circumferential surface of the lower end of the heater rod C51. A protrusion groove may be formed on an outer circumferential surface of the fitting groove C531. The protrusion C511 may be inserted into the protrusion groove.

On a side surface of the support C53, a flange C532 may be formed. The flange C532 may extend outward along a circumference from the side surface of the support C53. The flange C532 may be inserted into the mount (the bottom wall C22). The mount (the bottom wall C22) may be integrally coupled to the flange C532 by insert-injecting the heater holder C20 into the heater C50.

An inner circumferential surface of the mount (the bottom wall C22) may have a shape corresponding to an outer circumferential surface of the flange C532. The inner circumferential surface of the mount (the bottom wall C22) and the outer circumferential surface of the flange C532 may be engaged with each other in a circumferential direction. Accordingly, when the stick S is separated from or inserted into the heater C50, the heater C50 may not be separated from the heater holder C20.

Although not shown in the drawings, the aerosol generating device 1 according to an embodiment of the present disclosure may not be provided with the heater holder C20. The heater C50 may be fixed to the body C10. The heater C50 may be fixed to the bottom wall C112 of the body pipe C11 and may protrude upward from the first insertion space C14. An upper portion of the heater C50 may protrude into the second insertion space C24 by penetrating the through hole C35. A cavity may be formed inside the heater C50. An electrically conductive track and/or a temperature sensor (e.g., the sensor 13) may be mounted in the cavity of the heater C50. The electrically conductive track may be supplied with current from the power source 11 and may generate heat, and the heater C50 may be heated by the heat generated in the electrically conductive track.

As another example, the heater C50 may be fixed to the extractor C30. The heater C50 may be fixed to the bottom wall C32 of the extractor C30 and may protrude upward from the second insertion space C24. The extractor C30 may be detachably inserted into the first insertion space C14. When the extractor C30 is separated from the body C10, the heater C50 may be separated from the body C10 together with the extractor C30.

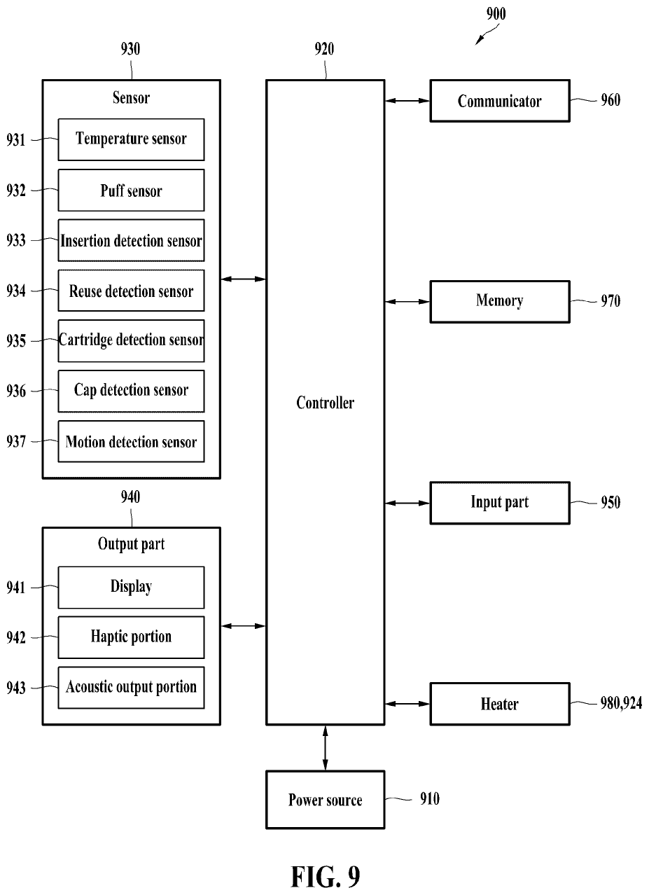

FIG. 9 is a block diagram of an aerosol generating device according to an embodiment of the present disclosure.

An aerosol generating device 900 may include a power source 910, a controller 920, a sensor 930, an output part 940, an input part 950, a communicator 960, memory 970, and at least one heater 980 and 924. However, an internal structure of the aerosol generating device 900 is not limited to what is shown in FIG. 9. It is to be understood by one of ordinary skill in the art to which the disclosure pertains that some of the components shown in FIG. 9 may be omitted or new components may be added according to the design of the aerosol generating device 900.

The sensor 930 may detect a state of the aerosol generating device 900 or a state of an environment around the aerosol generating device 900, and transmit the detected information to the controller 920. The controller 920 may control the aerosol generating device 900 to perform various functions, such as controlling the operation of a cartridge heater 924 and/or a heater 980, restricting smoking, determining whether a stick S and/or a cartridge 19 is inserted, and displaying a notification, based on the detected information.

The sensor 930 may include at least one of a temperature sensor 931, puff sensor 932, insertion detection sensor 933, reuse detection sensor 934, cartridge detection sensor 935, cap detection sensor 936, or motion detection sensor 937.

The temperature sensor 931 may detect a temperature at which the cartridge heater 924 and/or the heater 980 is heated. The aerosol generating device 900 may include a separate temperature sensor for detecting a temperature of the cartridge heater 924 and/or the heater 980, or the cartridge heater 924 and/or the heater 980 itself may serve as a temperature sensor.

The temperature sensor 931 may output a signal corresponding to a temperature of the cartridge heater 924 and/or the heater 980. For example, the temperature sensor 931 may include a resistance element of which a resistance value varies in response to temperature changes of the cartridge heater 924 and/or the heater 980. The resistance element may be implemented by a thermistor, which is an element using a property of varying resistance according to temperature. In this case, the temperature sensor 931 may output a signal corresponding to a resistance value of the resistance element as a signal corresponding to the temperature of the cartridge heater 924 and/or the heater 980. For example, the temperature sensor 931 may be configured as a sensor that detects a resistance value of the cartridge heater 924 and/or the heater 980. In this case, the temperature sensor 931 may output a signal corresponding to a resistance value of the cartridge heater 924 and/or the heater 980 as a signal corresponding to the temperature of the cartridge heater 924 and/or the heater 980.

The temperature sensor 931 may be disposed around the power source 910 to monitor a temperature of the power source 910. The temperature sensor 931 may be disposed adjacent to the power source 910. For example, the temperature sensor 931 may be attached to a surface of a battery, which is the power source 910. For example, the temperature sensor 931 may be mounted on a surface of a PCB.

The temperature sensor 931 may be disposed inside the body 10 to sense an internal temperature of the body 10.

The puff sensor 932 may detect a user's puff based on various physical changes in an airflow path. The puff sensor 932 may output a signal corresponding to a puff. For example, the puff sensor 932 may be a pressure sensor. The puff sensor 932 may output a signal corresponding to the internal pressure of the aerosol generating device 900. Here, the internal pressure of the aerosol generating device 900 may correspond to the pressure of an airflow path through which gas flows. The puff sensor 932 may be disposed corresponding to the airflow path through which gas flows in the aerosol generating device 900.

The insertion detection sensor 933 may detect an insertion and/or removal of a stick S. The insertion detection sensor 933 may detect a signal change according to the insertion and/or removal of the stick S. The insertion detection sensor 933 may be installed around an insertion space. The insertion detection sensor 933 may detect the insertion and/or removal of the stick S based on a change in dielectric constant inside the insertion space. For example, the insertion detection sensor 933 may be an inductive sensor and/or a capacitance sensor.

An inductive sensor may include at least one coil. The coil of the inductive sensor may be disposed adjacent to the insertion space. For example, when a magnetic field changes around a coil through which current flows, the properties of the current flowing in the coil may change according to Faraday's law of induction. The properties of the current flowing in the coil may include a frequency of an alternating current, a current value, a voltage value, an inductance value, an impedance value, or the like.

The inductive sensor may output a signal corresponding to the properties of the current flowing in the coil. For example, the inductive sensor may output a signal corresponding to an inductance value of the coil.

The capacitance sensor may include a conductor. The conductor of the capacitance sensor may be disposed adjacent to the insertion space. The capacitance sensor may output a signal corresponding to a surrounding electromagnetic property, for example, a capacitance around the conductor. For example, when a stick S including a wrapper made of a metal material is inserted into the insertion space, the electromagnetic properties around the conductor may change due to the wrapper of the stick S.

The reuse detection sensor 934 may detect whether the stick S is reused. The reuse detection sensor 934 may be a color sensor. The color sensor may detect a color of the stick S. The color sensor may detect a color of a portion of a wrapper that wraps the outside of the stick S. The color sensor may detect a value for an optical characteristic corresponding to a color of an object, based on light reflected from the object. For example, the optical characteristic may be a wavelength of light. The color sensor may be implemented as a single component with a proximity sensor or may be implemented as a separate component from the proximity sensor.

At least one of the wrappers making up the stick S may change color due to aerosol. The reuse detection sensor 934 may be disposed corresponding to a position where at least one of the wrappers whose color changes due to the aerosol is placed when the stick S is inserted into the insertion space. For example, before the stick S is used by the user, a color of at least one of the wrappers may be a first color. As at least one of the wrappers is moistened by aerosol generated by the aerosol generating device 900 while passing through the stick S, the color of the at least one of the wrappers may change to a second color. The color of the at least one of the wrappers may remain as the second color after changing from the first color to the second color.

The cartridge detection sensor 935 may detect a mounting and/or removal of the cartridge 19. The cartridge detection sensor 935 may be implemented by an inductance-based sensor, a capacitive sensor, a resistance sensor, a hall sensor (hall IC) using the Hall effect, or the like.

The cap detection sensor 936 may detect an attachment and/or removal of a cap.

When the cap is separated from the body 10, a portion of the body 10 and the cartridge 19 covered by the cap may be exposed to the outside. The cap detection sensor 936 may be implemented by a contact sensor, a hall sensor (hall IC), an optical sensor, or the like.

The motion detection sensor 937 may detect a motion of the aerosol generating device 900. The motion detection sensor 937 may be implemented as at least one of an acceleration sensor and a gyro sensor.

In addition to the sensors 931 to 937 described above, the sensor 930 may further include at least one of a humidity sensor, a pressure sensor, a magnetic sensor, a global positioning system (GPS), or a proximity sensor. Since the functions of each sensor may be intuitively inferred by a person skilled in the art from its name, a detailed description thereof is omitted.

The output part 940 may output information on a state of the aerosol generating device 900 to provide to the user. The output part 940 may include at least one of a display 941, a haptic portion 942, and an acoustic output portion 943, but is not limited thereto. When the display 941 and a touch pad form a layered structure to form a touch screen, the display 941 may be used as an input device in addition to an output device.

The display 941 may visually provide information on the aerosol generating device 900 to the user. For example, the information on the aerosol generating device 900 may be a variety of information such as a charging/discharging state of the power source 910 of the aerosol generating device 900, a preheating state of the heater 980, an insertion/removal state of the stick S and/or cartridge 19, a mounting/removal state of the cap, or a state (e.g., detection of an abnormal item) in which the use of the aerosol generating device 900 is restricted, and the display 941 may output the above-described information to the outside. For example, the display 941 may be in the form of a light-emitting diode (LED) light-emitting element. For example, the display 941 may be a liquid crystal display (LCD) panel, an organic LED (OLED) display panel, or the like.

The haptic portion 942 may convert an electrical signal into a mechanical stimulus or an electrical stimulus to provide tactile information on the aerosol generating device 900 to the user. For example, the haptic portion 942 may generate a vibration corresponding to the completion of an initial preheating when initial power is supplied to the cartridge heater 924 and/or the heater 980 for a set period of time. The haptic portion 942 may include a vibration motor, a piezoelectric element, or an electrical stimulation device.

The acoustic output portion 943 may audibly provide information on the aerosol generating device 900 to the user. For example, the acoustic output portion 943 may convert an electrical signal into an acoustic signal and output the acoustic signal to the outside.

The power source 910 may supply power used to operate the aerosol generating device 900. The power source 910 may supply power to heat the cartridge heater 924 and/or the heater 980. Additionally, the power source 910 may supply power required for an operation of other components provided in the aerosol generating device 900, such as the sensor 930, the output part 940, the input part 950, the communicator 960, and the memory 970. The power source 910 may be a rechargeable battery or a disposable battery. For example, the power source 910 may be a lithium polymer (LiPoly) battery, but is not limited thereto.

Although not shown in FIG. 9, the aerosol generating device 900 may further include power protection circuitry. The power protection circuitry may be electrically connected to the power source 910 and may include a switching element.

The power protection circuitry may block a power path to the power source 910 according to certain conditions. For example, the power protection circuitry may block a power path to the power source 910 when a voltage level of the power source 910 is greater than a first voltage corresponding to overcharge. For example, the power protection circuitry may block a power path to the power source 910 when a voltage level of the power source 910 is less than a second voltage corresponding to over-discharge.

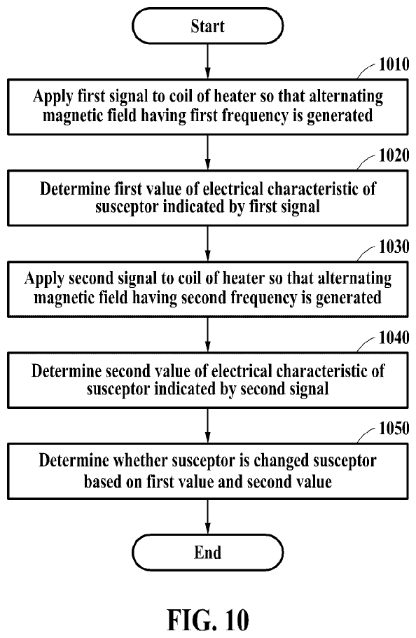

The heater 980 may receive power from the power source 910 to heat a medium or aerosol generating material within the stick S. Although not shown in FIG. 10, the aerosol generating device 900 may further include power conversion circuitry (e.g., a DC/DC converter) that converts power from the power source 910 to supply to the cartridge heater 924 and/or the heater 980. Additionally, when the aerosol generating device 900 generates aerosol by an induction heating scheme, the aerosol generating device 900 may further include a DC/AC converter that converts direct current of the power source 910 into alternating current.

The controller 920, the sensor 930, the output part 940, the input part 950, the communicator 960, and the memory 970 may receive power from the power source 910 and perform functions. Although not shown in FIG. 1, the aerosol generating device 900 may further include power conversion circuitry that converts power of the power source 910 to supply to respective components, for example, low-dropout (LDO) circuitry or voltage regulator circuitry. Also, although not shown in FIG. 9, a noise filter may be provided between the power source 910 and the heater 980. The noise filter may be a low-pass filter. The low-pass filter may include at least one inductor and a capacitor. A cutoff frequency of the low-pass filter may correspond to a frequency of a high-frequency switching current applied from the power source 910 to the heater 980. By the low-pass filter, it may be possible to prevent high-frequency noise components from being applied to the sensor 930, such as the insertion detection sensor 933.

In an embodiment, the cartridge heater 924 and/or the heater 980 may be formed of any suitable electrically resistive material. For example, the suitable electrically resistive material may be metals or metal alloys including, but not limited to, titanium, zirconium, tantalum, platinum, nickel, cobalt, chromium, hafnium, niobium, molybdenum, tungsten, tin, gallium, manganese, iron, copper, stainless steel, nichrome, and the like. Additionally, the heater 980 may be implemented as a metal heating wire, a metal heating plate in which electrically conductive tracks are arranged, a ceramic heating element, and the like, but is not limited thereto.

In another embodiment, the heater 980 may be an inductive heating type heater. For example, the heater 980 may include a susceptor that heats an aerosol generating material by generating heat through a magnetic field applied by a coil.

The input part 950 may receive information input from a user or output information to the user. For example, the input part 950 may be a touch panel. The touch panel may include at least one touch sensor that detects a touch. For example, the touch sensor may include, but is not limited to, a capacitive touch sensor, a resistive touch sensor, a surface acoustic wave touch sensor, an infrared touch sensor, or the like.

The display 941 and the touch panel may be implemented as a single panel. For example, the touch panel may be inserted (e.g., an on-cell type or in-cell type) into the display 941. For example, the touch panel may be added-on (e.g., an add-on type) the display panel 941.

The input part 950 may include a button, a keypad, a dome switch, a jog wheel, or a jog switch, but is not limited thereto.

The memory 970, which is hardware for storing various pieces of data processed in the aerosol generating device 900, may store data processed by the controller 920 and data to be processed by the controller 920. The memory 970 may include at least one type of storage medium among a flash memory type memory, a hard disk type memory, a multimedia card micro type memory, a card type memory (e.g., a secure digital (SD) or extreme digital (XD) memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 970 may store an operating time of the aerosol generating device 900, a maximum number of puffs, a current number of puffs, at least one temperature profile, data associated with a smoking pattern of the user, or the like.

The communicator 960 may include at least one component for communicating with another electronic device. For example, the communicator 960 may include at least one of a short-range wireless communication unit and a wireless communication unit.

The short-range wireless communication unit may include a Bluetooth communication unit, a Bluetooth low energy (BLE) communication unit, a near field communication unit, a wireless area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit may include, for example, a cellular network communication unit, an Internet communication unit, a computer network (e.g., a local area network (LAN) or a wide-area network (WAN)) communication unit, or the like. However, embodiments are not limited thereto.

Although not shown in FIG. 9, the aerosol generating device 900 may further include a connection interface, such as a universal serial bus (USB) interface and may transmit and receive information or charge the power source 910 by connecting to another external device through the connection interface, such as a USB interface.

The controller 920 may control the overall operation of the aerosol generating device 900. In an embodiment, the controller 920 may include at least one processor. The processor may be implemented as an array of a plurality of logic gates or may be implemented as a combination of a general-purpose microprocessor and a memory in which a program executable by the microprocessor is stored. In addition, it is to be understood by one of ordinary skill in the art to which the present disclosure pertains that the processor may be implemented in other types of hardware.

The controller 920 may control a temperature of the heater 980 by controlling the supply of power from the power source 910 to the heater 980. The controller 920 may control a temperature of the cartridge heater 924 and/or the heater 980 based on a temperature of the cartridge heater 924 and/or the heater 980 sensed by the temperature sensor 931. The controller 920 may adjust the power supplied to the cartridge heater 924 and/or the heater 980 based on the temperature of the cartridge heater 924 and/or the heater 980. For example, the controller 920 may determine a target temperature for the cartridge heater 924 and/or the heater 980 based on a temperature profile stored in the memory 970.

The aerosol generating device 900 may include power supply circuitry (not shown) electrically connected to the power source 910 between the power source 910 and the cartridge heater 924 and/or the heater 980. The power supply circuitry may be electrically connected to the cartridge heater 924, the heater 980, or the induction coil 181. The power supply circuitry may include at least one switching element. The switching element may be implemented by a bipolar junction transistor (BJT), a field effect transistor (FET), or the like.

The controller 920 may control the power supply circuitry.

The controller 920 may control power supply by controlling a switching of the switching element of the power supply circuitry. The power supply circuitry may be an inverter that converts direct current power output from the power source 910 into alternating current power. For example, the inverter may be configured as full-bridge circuitry or half-bridge circuitry including a plurality of switching elements.

The controller 920 may turn on a switching element such that power is supplied from the power source 910 to the cartridge heater 924 and/or the heater 980. The controller 920 may turn off the switching element such that power is cut off to the cartridge heater 924 and/or the heater 980. The controller 920 may control current supplied from the power source 910 by adjusting a frequency and/or duty ratio of a current pulse input to the switching element.

The controller 920 may control a voltage output from the power source 910 by controlling a switching of a switching element of the power supply circuitry. A power conversion circuitry may convert the voltage output from the power source 910. For example, the power conversion circuitry may include a buck converter that steps-down the voltage output from the power source 910. For example, the power conversion circuitry may be implemented through a buck-boost converter, a zener diode, or the like.

The controller 920 may control an on/off operation of the switching element included in the power conversion circuitry to adjust a level of the voltage output from the power conversion circuitry. When an on state of the switching element continues, the level of the voltage output from the power conversion circuitry may correspond to the level of the voltage output from the power source 910. The duty ratio for the on/off operation of the switching element may correspond to a ratio of the voltage output from the power conversion circuitry to the voltage output from the power source 910. As the duty ratio for the on/off operation of the switching element decreases, the level of the voltage output from the power conversion circuitry may decrease. The heater 980 may be heated based on the voltage output from the power conversion circuitry.

The controller 920 may control power to be supplied to the heater 980 using at least one of a pulse width modulation (PWM) scheme and a proportional-integral-differential (PID) scheme.

For example, the controller 920 may control a current pulse having a predetermined frequency and duty ratio to be supplied to the heater 980 using the PWM scheme. The controller 920 may control the power supplied to the heater 980 by adjusting the frequency and duty ratio of the current pulse.

For example, the controller 920 may determine a target temperature that is a target of control, based on a temperature profile. The controller 920 may control the power supplied to the heater 980 by using a PID scheme, which is a feedback control scheme using a difference value between a temperature of the heater 980 and the target temperature, a value obtained by integrating the difference value over time, and a value obtained by differentiating the difference value over time.

The controller 920 may prevent the cartridge heater 924 and/or the heater 980 from overheating. For example, the controller 920 may control an operation of the power conversion circuitry to cut off the supply of power to the cartridge heater 924 and/or the heater 980 based on the temperature of the cartridge heater 924 and/or the heater 980 exceeding a preset limit temperature. For example, the controller 920 may reduce the amount of power supplied to the cartridge heater 924 and/or the heater 980 by a certain percentage in response to the temperature of the cartridge heater 924 and/or the heater 980 exceeding the preset limit temperature. For example, the controller 920 may determine that the aerosol generating material contained in the cartridge 19 is exhausted in response to the temperature of the cartridge heater 924 exceeding the limit temperature and may cut off the power supply to the cartridge heater 924.

The controller 920 may control the charging and discharging of the power source 910. The controller 920 may determine a temperature of the power source 910 based on an output signal of the temperature sensor 931.

When a power line is connected to a battery terminal of the aerosol generating device 900, the controller 920 may determine whether the temperature of the power source 910 is greater than a first limit temperature, which may be a reference for blocking the charging of the power source 910. The controller 920 may control the power source 910 to be charged based on a preset charging current when the temperature of the power source 910 is lower than the first limit temperature. The controller 920 may block the charging of the power source 910 when the temperature of the power source 910 is greater than the first limit temperature.

When the power of the aerosol generating device 900 is turned on, the controller 920 may determine whether the temperature of the power source 910 is greater than a second limit temperature, which may be a reference for blocking the discharge of the power source 910. When the temperature of the power source 910 is lower than the second limit temperature, the controller 920 may control to use power stored in the power source 910. When the temperature of the power source 910 is greater than the second limit temperature, the controller 920 may stop using the power stored in the power source 910.

The controller 920 may calculate a remaining capacity of the power stored in the power source 910. For example, the controller 920 may calculate the remaining capacity of the power source 910 based on a voltage and/or current sensing value of the power source 910.

The controller 920 may determine whether a stick S is inserted into the insertion space via the insertion detection sensor 933. The controller 920 may determine that the stick S is inserted based on an output signal of the insertion detection sensor 933. When it is determined that the stick S is inserted into the insertion space, the controller 920 may control to supply power to the cartridge heater 924 and/or the heater 980. For example, the controller 920 may supply power to the cartridge heater 924 and/or the heater 980 based on a temperature profile stored in the memory 970.

The controller 920 may determine whether the stick S is removed from the insertion space. For example, the controller 920 may determine whether the stick S is removed from the insertion space via the insertion detection sensor 933. For example, the controller 920 may determine that the stick S has been removed from the insertion space when a temperature of the heater 980 is greater than a limit temperature or when a temperature change gradient of the heater 980 is greater than a set gradient. When it is determined that the stick S has been removed from the insertion space, the controller 920 may cut off the power supply to the cartridge heater 924 and/or the heater 980.

The controller 920 may control a power supply time and/or power supply amount to the heater 980 depending on a state of a stick S detected by the sensor 930. The controller 920 may identify a level range that includes a level of a signal of a capacitance sensor based on a lookup table. The controller 920 may determine a moisture content of the stick S according to the identified level range.

When the stick S is in an over-moistened state, the controller 920 may control the power supply time to the heater 980 to increase a preheating time of the stick S compared to a normal state.

The controller 920 may determine whether a stick S inserted into the insertion space is reused, via the reuse detection sensor 934. For example, the controller 920 may compare a sensing value of a signal of the reuse detection sensor 934 with a first reference range that includes a first color, and when the sensing value is included in the first reference range, the controller 920 may determine that the stick S has not been used. For example, the controller 920 may compare a sensing value of a signal of the reuse detection sensor 934 with a second reference range that includes a second color, and when the sensing value is included in the second reference range, the controller 920 may determine that the stick S has been used. When it is determined that the stick S has been used, the controller 920 may cut off the supply of power to the cartridge heater 924 and/or the heater 980.

The controller 920 may determine whether the cartridge 19 is coupled and/or removed through the cartridge detection sensor 935. For example, the controller 920 may determine whether the cartridge 19 is coupled and/or removed based on a sensing value of a signal of the cartridge detection sensor 935.

The controller 920 may determine whether an aerosol generating material of the cartridge 19 is exhausted. For example, the controller 920 may preheat the cartridge heater 924 and/or the heater 980 by applying power and determine whether a temperature of the cartridge heater 924 exceeds a limit temperature in a preheating period, and when the temperature of the cartridge heater 924 exceeds the limit temperature, the controller 920 may determine that the aerosol generating material of the cartridge 19 is exhausted. When it is determined that the aerosol generating material of the cartridge 19 is exhausted, the controller 920 may cut off the power supply to the cartridge heater 924 and/or heater 980.

The controller 920 may determine whether the cartridge 19 is available for use. For example, the controller 920 may determine that the cartridge 19 is not available for use when a current number of puffs is greater than a maximum number of puffs set for the cartridge 19 based on data stored in the memory 970. For example, the controller 920 may determine that the cartridge 19 is not available for use when a total time that the heater 924 has been heated is greater than a preset maximum time or a total amount of power supplied to the heater 924 is greater than a preset maximum amount of power.

The controller 920 may determine an inhalation of the user through the puff sensor 932. For example, the controller 920 may determine whether a puff is generated based on a sensing value of a signal of the puff sensor 932. For example, the controller 920 may determine an intensity of the puff based on a sensing value of a signal of the puff sensor 932.

When the number of puffs reaches a preset maximum number of puffs or when no puffs are detected for a preset period of time, the controller 920 may cut off the power supply to the cartridge heater 924 and/or heater 980.

The controller 920 may determine whether a cap is coupled and/or removed through the cap detection sensor 936. For example, the controller 920 may determine whether the cap is coupled and/or removed based on a sensing value of a signal of the cap detection sensor 936.

The controller 920 may control the output part 940 based on a result detected by the sensor 930. For example, when the number of puffs counted through the puff sensor 932 reaches a preset number of puffs, the controller 920 may notify the user in advance that the aerosol generating device 900 is soon to be terminated, through at least one of the display 941, the haptic portion 942, and the acoustic output portion 943. For example, the controller 920 may notify the user through the output part 940 based on a determination that a stick S is not present in the insertion space. For example, the controller 920 may notify the user through the output part 940 based on a determination that the cartridge 19 and/or the cap is not mounted. For example, the controller 920 may transmit information on a temperature of the cartridge heater 924 and/or the heater 980 to the user through the output part 940.

The controller 920 may store and update a history of an event that occurred in the memory 970 based on the occurrence of a given event. The event may include operations such as the detection of an insertion of the stick S, the initiation of the heating of the stick S, the detection of a puff, the termination of a puff, the detection of the overheating of the cartridge heater 924 and/or the heater 980, the detection of an overvoltage application to the cartridge heater 924 and/or the heater 980, the termination of the heating of the stick S, the power on/off of the aerosol generating device 900, the initiation of the charging of the power source 910, the detection of an overcharge of the power source 910, the termination of the charging of the power source 910, or the like, performed in the aerosol generating device 900. The history of an event may include a date and time the event occurred, log data corresponding to the event, or the like. For example, when a given event is the detection of an insertion of the stick S, log data corresponding to the event may include data on a sensing value of the insertion detection sensor 933. For example, when a given event is the detection of the overheating of the cartridge heater 924 and/or the heater 980, log data corresponding to the event may include data on a temperature of the cartridge heater 924 and/or the heater 980, a voltage applied to the cartridge heater 924 and/or the heater 980, a current flowing through the cartridge heater 924 and/or the heater 980, or the like.

The controller 920 may control to form a communication link with an external device, such as a mobile terminal of the user. When data related to authentication is received from the external device through the communication link, the controller 920 may release a restriction on the use of at least one function of the aerosol generating device 900. Here, the data related to authentication may include data indicating the completion of user authentication for a user corresponding to an external device. The user may perform user authentication through the external device. The external device may determine whether user data is valid based on the user's birthday, a unique number representing the user, or the like, and may receive data related to the authority for use of the aerosol generating device 900 from an external server. The external device may transmit data indicating the completion of user authentication to the aerosol generating device 900 based on the data related to the authority for use. When the user authentication is completed, the controller 920 may release the restriction on the use of at least one function of the aerosol generating device 900. For example, when the user authentication is completed, the controller 920 may release the restriction on the use of a heating function that supplies power to the heater 980.

The controller 920 may transmit data on a state of the aerosol generating device 900 to the external device through a communication link formed with the external device. Based on the received state data, the external device may output a remaining capacity, operating state, or the like of the power source 910 of the aerosol generating device 900 through a display of the external device.

The external device may transmit a location search request to the aerosol generating device 900 based on an input that initiates location search of the aerosol generating device 900. When a location search request from the external device is received, the controller 920 may control at least one of the output devices to perform an operation corresponding to the location search based on the received location search request. For example, in response to a location search request, the haptic portion 942 may generate vibration. For example, in response to a location search request, the display 941 may output an object corresponding to the location search and the end of the search.

The controller 920 may control to perform a firmware update when receiving firmware data from the external device. The external device may identify a current version of the firmware of the aerosol generating device 900 and determine whether there is a new version of the firmware. When an input requesting to download firmware is received, the external device may receive a new version of firmware data and transmit the new version of firmware data to the aerosol generating device 900. The controller 920 may control the firmware update of the aerosol generating device 900 to be performed upon receiving the new version of firmware data.

The controller 920 may transmit data on sensing values of at least one sensor 930 to an external server (not shown) through the communicator 960 and receive, from the server, and store a training model generated by learning the sensing values through machine learning such as deep learning. The controller 920 may perform operations such as determining a user's suction pattern and generating a temperature profile using the training model received from the server. The controller 920 may store sensing value data of the at least one sensor 930 and data for training an artificial neural network (ANN) in the memory 970. For example, the memory 970 may store a database for each configuration provided in the aerosol generating device 900 to train the ANN, and weights and biases forming the ANN structure. The controller 920 may learn the data on sensing values of the at least one sensor 930, the user's suction pattern, temperature profile, or the like, stored in the memory 970, and generate at least one training model used for determining the user's suction pattern, generating a temperature profile, or the like.

The aerosol generating device 900 may generate an alternating magnetic field by applying a signal to the coil of the heater. The generated alternating magnetic field may cause eddy currents to flow in the susceptor, and an induction heating phenomenon may occur in which the temperature of the susceptor increases due to the heat generated by the eddy currents and the resistance of the susceptor. The aerosol generating device 900 may generate aerosol by heating an aerosol generating article via the heat of the susceptor. The aerosol generating device 900 may perform heating of the aerosol generating article for optimal smoking by controlling a signal applied to the coil of the heater such that the temperature of the susceptor corresponds to a preset temperature profile. When a reference susceptor is coupled to the aerosol generating device 900, the aerosol generating device 900 may apply a reference signal to the coil of the heater such that the reference susceptor follows the temperature profile. When a susceptor having electrical characteristics different from those of a reference susceptor is coupled to the aerosol generating device 900, the aerosol generating device 900 may determine a signal to be applied to the coil of the heater by varying the frequency, size, duty ratio, or the like of the reference signal based on a control characteristic determined in response to the electrical characteristics of the susceptor. Here, the control characteristic may be a parameter that compensates the reference signal such that the susceptor follows the temperature profile for a susceptor having different electrical characteristics from the reference susceptor.

The susceptor is a component that is in direct contact with the aerosol generating article and transfers heat in the aerosol generating device 900, so as the number of times of smoking accumulates, foreign substances may accumulate, and since cleaning is inconvenient, the susceptor may be configured to be replaceable. When the susceptor is replaced in the aerosol generating device 900, the control characteristic of the replaced susceptor may be determined and a signal applied to the coil of the heater may be controlled differently. Therefore, in order for the aerosol generating device 900 coupled with a replaceable susceptor to effectively perform an aerosol generating method, a method of determining a change of the susceptor may be required.

FIG. 10 is a flowchart of a method of determining whether a susceptor is a changed susceptor, according to an embodiment of the present disclosure.

The following operations 1010 to 1050 may be performed by an aerosol generating device (e.g., the aerosol generating device 1 of FIGS. 1 to 3 or the aerosol generating device 900 of FIG. 9). The aerosol generating device may include a heater (e.g., the heater 18 of FIGS. 1 to 3, the heater A33 of FIG. 5, the heater C50 of FIGS. 6 to 8, or the heaters 980 and 924 of FIG. 9) and a controller (e.g., the controller 12 of FIGS. 1 to 3, the controller A102 of FIG. 5, or the controller 920 of FIG. 9). For example, the heater may include a coil (e.g., the induction coil 181 of FIGS. 2 and 3, the induction coil A13 of FIG. 5, or the induction coil C15 of FIGS. 6 and 7).

In operation 1010, the controller of the aerosol generating device may apply a first signal to a coil of a heater so that an alternating magnetic field having a first frequency is generated. The first signal may include a preset current, voltage, and duty ratio as a first test signal.

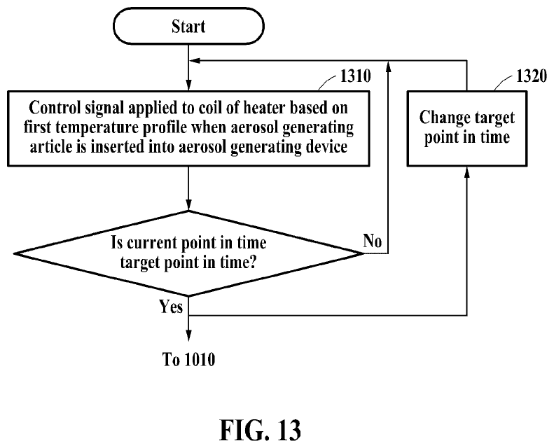

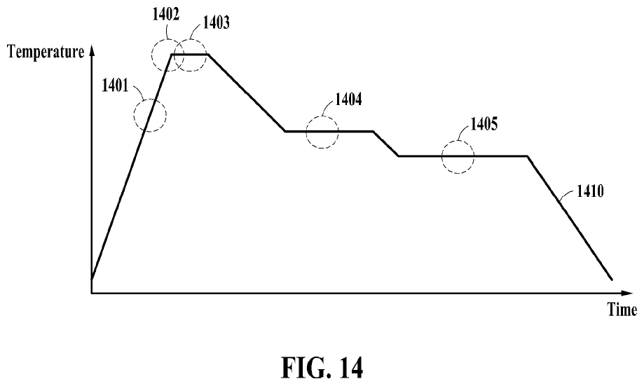

According to an embodiment, when an aerosol generating article is inserted into the aerosol generating device, the aerosol generating device may control a signal applied to the coil of the heater based on a first temperature profile, and when it is determined that a current point in time corresponds to a first point in time of the first temperature profile, operation 1010 may be performed. The first temperature profile may be a temperature profile that controls a temperature of a susceptor to heat the aerosol generating article to an optimal temperature during a smoking process. The first signal may be applied to the coil of the heater at the first point in time of the first temperature profile to detect a change in the susceptor during the heating process of the aerosol generating article. A method of determining whether a susceptor has changed while the aerosol generating device is controlled based on a first temperature profile is described in detail with reference to FIGS. 13 and 14 below.

According to an embodiment, the aerosol generating device may include a DC/AC inverter and an amplifier to generate the first signal. For example, the amplifier may include a D-class amplifier or an E-class amplifier.

According to an embodiment, the first frequency may be a frequency greater than a range of natural frequencies (or matching frequencies) of susceptors disposed within the aerosol generating device. For example, a plurality of susceptors may have different natural frequencies, but the different natural frequencies may be within a certain range. A natural frequency of a susceptor may be a frequency of a signal capable of inducing the largest eddy current in the susceptor. For example, when the range of natural frequencies is 230 KHz to 250 KHz, the first frequency may be 270 KHz.

According to an embodiment, an operation of applying the first signal to the coil so that the temperature of the susceptor does not increase due to eddy currents induced in the susceptor by the first signal may be performed for a short period of time (e.g., several milliseconds).

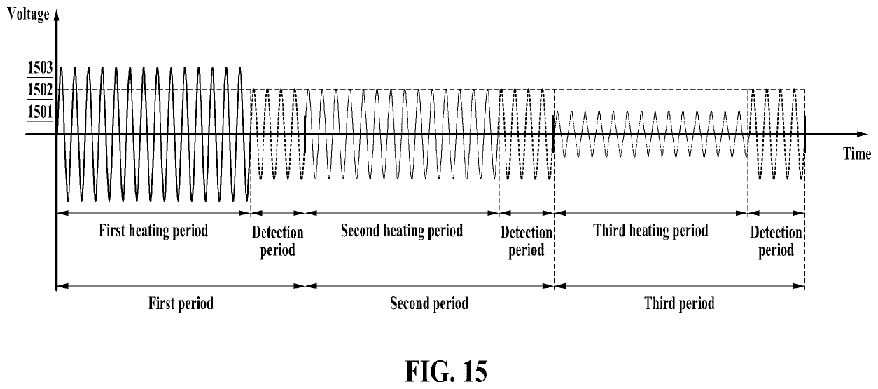

According to an embodiment, a voltage of the first signal may be lower than a preset voltage so that the temperature of the susceptor does not increase due to the eddy currents induced in the susceptor by the first signal. The voltage of the first signal set lower than the preset voltage is described in detail with reference to FIG. 15 below.

According to an embodiment, the susceptor may not be electrically connected to the aerosol generating device. Electricity may not flow from the aerosol generating device to the susceptor, but alternating magnetic fields generated by the aerosol generating device and the coils of the aerosol generating device may cause electromagnetic induction in the susceptor, causing eddy currents to flow in the susceptor.

According to an embodiment, the susceptor may be disposed inside the aerosol generating article when the aerosol generating article is inserted into the aerosol generating device. For example, the susceptor may be a tubular heating element, a plate-type heating element, a needle-type heating element, or a rod-type heating element.

According to an embodiment, the susceptor may be included in an aerosol generating article that is inserted into the aerosol generating device, such as the susceptor SS of FIG. 3. For example, the susceptor may be included in a filter paper of the aerosol generating article. For example, the susceptor may be included in a tobacco rod of the aerosol generating article.

In operation 1020, the controller of the aerosol generating device may determine a first value of an electrical characteristic of the susceptor indicated by the first signal. For example, the electrical characteristic may be at least one of a current, voltage or power of a first output signal appearing at an output end of the coil of the heater. The determining of the first value of the electrical characteristic of the susceptor may include determining the first value of the electrical characteristic of the susceptor based on at least one of a current, voltage, or power of the first output signal appearing at the output end of the coil of the heater. As the alternating magnetic field generated by the coil of the heater generates an eddy current in the susceptor, a portion of the electrical energy of the first signal may be transferred to the susceptor, and the current, voltage, or power of the first signal may be different from the current, voltage, or power of the first output signal.

According to an embodiment, the aerosol generating device may further include detection circuitry for determining the first value of an electrical characteristic of the susceptor indicated by the first signal at an output terminal of the coil of the heater. The detection circuitry may not be electrically connected to the susceptor.

In operation 1030, the controller of the aerosol generating device may apply a second signal to the coil of the heater so that an alternating magnetic field having a second frequency is generated. The second signal may include a preset current, voltage, and duty ratio as a second test signal.

According to an embodiment, when an aerosol generating article is inserted into the aerosol generating device, the aerosol generating device may control a signal applied to the coil of the heater based on a first temperature profile, and when it is determined that a current point in time corresponds to a first point in time of the first temperature profile, operation 1030 may be performed. Operation 1030 may be performed sequentially after operation 1010 is performed or after a preset delay.

According to an embodiment, the second frequency may be a frequency greater than a range of natural frequencies of susceptors disposed within the aerosol generating device. For example, when the range of natural frequencies is 230 KHz to 250 KHz, the second frequency may be 280 KHz.

According to an embodiment, an operation of applying the second signal to the coil so that the temperature of the susceptor does not increase due to eddy currents induced in the susceptor by the second signal may be performed for a short period of time (e.g., several milliseconds).

According to an embodiment, a voltage of the second signal may be lower than a preset voltage so that the temperature of the susceptor does not increase due to the eddy currents induced in the susceptor by the second signal.

In operation 1040, the controller of the aerosol generating device may determine a second value of an electrical characteristic of the susceptor indicated by the second signal. For example, the electrical characteristic may be at least one of a current, voltage or power of a second output signal appearing at an output end of the coil of the heater. The determining of the second value of the electrical characteristic of the susceptor may include determining the second value of the electrical characteristic of the susceptor based on at least one of a current, voltage, or power of the second output signal appearing at the output end of the coil of the heater.

In operation 1050, the controller of the aerosol generating device may determine whether the susceptor is a changed susceptor based on the first value and the second value of the electrical characteristic of the susceptor. For example, when at least one of the first value and the second value is different from a previous first value and a previous second value measured for a previous susceptor, the controller of the aerosol generating device may determine that the susceptor is a changed susceptor. For example, when the first value and the second value of the susceptor are equal to the previous first value and the previous second value measured for the previous susceptor, the controller of the aerosol generating device may determine that the susceptor is an unchanged susceptor. For example, when a difference between the first value of the susceptor and the previous first value of the previous susceptor is less than a preset difference, the first value of the susceptor and the previous first value of the previous susceptor may be considered to be equal.

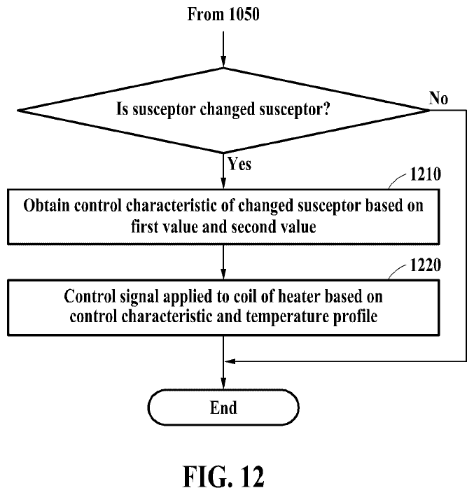

According to an embodiment, when it is determined that the susceptor is changed, a control characteristic of the changed susceptor may be obtained based on the first value and the second value. The signal applied to the coil of the heater may be controlled based on the control characteristic of the changed susceptor. A method of controlling the signal applied to the coil of the heater based on the control characteristic is described in detail below with reference to FIG. 12.

According to an embodiment, when the susceptor of the aerosol generating device is determined to be a changed susceptor, the aerosol generating device may determine whether a current state is a target state that satisfies a preset condition. For example, the target state may be a state in which an aerosol generating article is not inserted into the aerosol generating device. For example, the target state may be a state in which a body temperature of the aerosol generating device is within a target temperature range. For example, the target state may be a state in which a user executes a user calibration operation. When the current state is determined to be the target state, a calibration signal may be applied to the coil of the heater, and the control characteristic of the changed susceptor may be obtained based on at least one of a current, voltage, or power of a calibration output signal appearing at the output end of the coil of the heater. For example, the calibration signal may be a signal of a power profile that controls the power applied to the coil of the heater to obtain the control characteristic of a susceptor by the aerosol generating device. The signal applied to the coil of the heater may be controlled based on the control characteristic of the changed susceptor.

According to an embodiment, it is determined that the susceptor is not changed, the controller of the aerosol generating device may maintain a preset control characteristic for the susceptor.

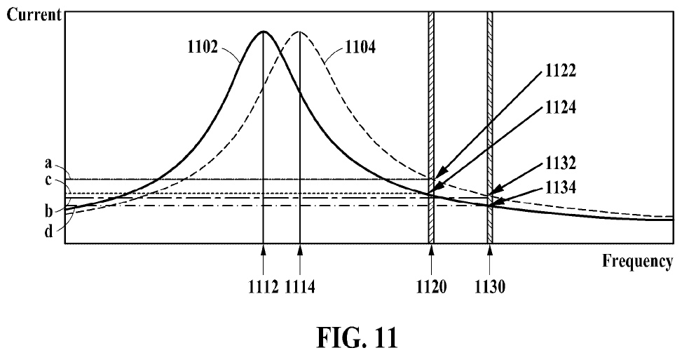

FIG. 11 is a diagram illustrating trajectories of eddy currents in a susceptor as indicated by a frequency of a signal, according to an embodiment of the present disclosure.

According to an embodiment, a first susceptor and a second susceptor may exhibit different electrical characteristics for the same signal. For example, as a first natural frequency 1112 of the first susceptor and a second natural frequency 1114 of the second susceptor are different from each other, a first eddy current trajectory 1102 of the first susceptor and a second eddy current trajectory 1104 of the second susceptor, which are indicated by the frequency of a provided signal, may be different. For example, even when the same manufacturing process and the same materials are used, the first natural frequency 1112 of the first susceptor and the second natural frequency 1114 of the second susceptor may differ from each other due to tolerances occurring during a manufacturing process of the susceptors. For example, each of the susceptors may be manufactured to have different electrical characteristics.

When an aerosol generating device (e.g., the aerosol generating device 1 of FIGS. 1 to 3 or the aerosol generating device 900 of FIG. 9) is able to perform a frequency sweep for the entire frequency band, the first eddy current trajectory 1102 of the first susceptor and the second eddy current trajectory 1104 of the second susceptor may be generated. The aerosol generating device may determine that the first susceptor and the second susceptor are not identical when the first eddy current trajectory 1102 of the first susceptor and the second eddy current trajectory 1104 of the second susceptor are not identical. However, for the aerosol generating device to perform a frequency sweep over the entire frequency band, a great amount of computation and processing time may be required.

According to an embodiment, the aerosol generating device may determine a first value c and a second value d of eddy currents appearing in the first susceptor using a first signal having a first frequency 1120 and a second signal having a second frequency 1130, to reduce the amount of computation and processing time required. The aerosol generating device may store in advance a first value a and a second value b of eddy currents appearing in the second susceptor using the first signal having the first frequency 1120 and the second signal having the second frequency 1130. For example, the first susceptor may be a replaced susceptor, and the second susceptor may be a susceptor before being replaced.

The aerosol generating device may determine whether the first value c and the second value d for the first susceptor and the first value a and the second value b for the second susceptor are the same, respectively. For example, the aerosol generating device may determine the first susceptor and the second susceptor to be the same susceptor when the first value c and the second value d for the first susceptor and the first value a and the second value b for the second susceptor are the same, respectively. For example, the aerosol generating device may determine that the first susceptor and the second susceptor are not the same susceptors when at least one of the first value c and the second value d for the first susceptor is not equal to the first value a and the second value b for the second susceptor.

According to an embodiment, a magnitude of an eddy current of the susceptor indicated by a signal frequency may be indirectly obtained from the detection circuitry connected to the output end of the coil of the heater. Since at least a portion of the electrical energy of a signal applied to the coil of the heater may be absorbed by the susceptor to generate an eddy current, the detection circuitry may indirectly obtain the magnitude of the eddy current of the susceptor by comparing a current, voltage or power of the signal applied to the coil of the heater with a current, voltage or power of the output signal. When an eddy current of the susceptor is indirectly obtained through the detection circuitry, the susceptor of the aerosol generating device may be easily replaced since the susceptor is not electrically connected to other components of the aerosol generating device.

FIG. 12 is a flowchart of a method of obtaining a control characteristic of a susceptor according to an embodiment of the present disclosure.

According to an embodiment, the following operations 1210 and 1220 may be performed by an aerosol generating device (e.g., the aerosol generating device 1 of FIGS. 1 to 3, the aerosol generating device 9 of FIGS. 4 to 8, or the aerosol generating device 900 of FIG. 9). For example, operations 1210 and 1220 may be performed after operation 1050 described above with reference to FIG. 10 is performed. The aerosol generating device may include a controller including at least one processor and memory storing instructions executable by the controller.

In operation 1210, when a susceptor is a changed susceptor, the aerosol generating device may obtain a control characteristic of the changed susceptor based on a first value and a second value. When a reference susceptor is coupled to the aerosol generating device, the aerosol generating device may apply a reference signal to the coil of the heater so that the reference susceptor follows a temperature profile (e.g., a first temperature profile). For example, the reference susceptor may be a susceptor used to obtain data in an experimental environment, and the reference signal may be a signal applied to the coil of the heater so that a temperature of the reference susceptor follows the first temperature profile. Here, the control characteristic of the susceptor may be a parameter for correcting the reference signal so that a susceptor having different electrical characteristics from the reference susceptor follows the first temperature profile.

In operation 1220, the aerosol generating device may control the signal applied to the coil of the heater based on the control characteristic and the temperature profile (e.g., the first temperature profile) of the changed susceptor. The changed susceptor may be controlled to follow the temperature profile based on a signal generated by changing a frequency, size, duty ratio, or the like of the reference signal based on a control characteristic determined in response to the electrical characteristics of the changed susceptor.

FIG. 13 is a flowchart of a method of determining whether a susceptor is a changed susceptor at a target point in time in a first temperature profile, according to an embodiment of the present disclosure, and FIG. 14 is a diagram illustrating a first temperature profile and a target point in time, according to an embodiment of the present disclosure.

According to an embodiment, the following operations 1310 and 1320 may be performed by an aerosol generating device (e.g., the aerosol generating device 1 of FIGS. 1 to 3, the aerosol generating device 9 of FIGS. 4 to 8, or the aerosol generating device 900 of FIG. 9). For example, operations 1310 and 1320 may be performed before operation 1010 described above with reference to FIG. 10 is performed. The aerosol generating device may include a controller including at least one processor and memory storing instructions executable by the controller.

In operation 1310, the aerosol generating device may control a signal applied to the coil of the heater based on a first temperature profile when an aerosol generating article is inserted into the aerosol generating device. The first temperature profile may be a temperature profile that controls a temperature of the susceptor to heat the aerosol generating article to an optimal temperature during a smoking process. For example, the first temperature profile may be a temperature profile 1410 described below with reference to FIG. 14.

According to an embodiment, the aerosol generating device may determine whether a current point in time corresponds to a target point in time of the first temperature profile, and when the current point in time corresponds to the target point in time, operation 1010 described above with reference to FIG. 10 may be performed. For example, when it is determined that the current point in time corresponds to a first point in time of the first temperature profile, a first signal may be applied to the coil of the heater so that an alternating magnetic field having a first frequency is generated, and a second signal may be applied to the coil of the heater so that an alternating magnetic field having a second frequency is generated. When the method of determining a susceptor change is performed at a target point in time in the first temperature profile, overheating or inaccurate control of the aerosol generating device due to the changed susceptor may be prevented by detecting a change in the susceptor during a heating process of the aerosol generating article.

In operation 1320, the aerosol generating device may change the target point in time. According to an embodiment, operations 1010 to 1050 described above with reference to FIG. 10 may be performed multiple times at a plurality of points in time while the aerosol generating device is controlled based on the first temperature profile. For example, after the first signal and the second signal are respectively applied to the coil of the heater at the first point in time of the first temperature profile, when the aerosol generating device determines that the current point in time corresponds to the second point in time of the first temperature profile, the aerosol generating device may apply a third signal to the coil of the heater so that an alternating magnetic field having a first frequency is generated, determine a third value of the electrical characteristic of the susceptor indicated by the third signal, apply a fourth signal to the coil of the heater so that an alternating magnetic field having a second frequency is generated, and determine a fourth value of the electrical characteristic of the susceptor indicated by the fourth signal. According to an embodiment, the first signal and the third signal may be the same signal, and the second signal and the fourth signal may be the same signal. The aerosol generating device may determine whether the susceptor is a changed susceptor based on the third value and the fourth value.

According to an embodiment, operations 1010 to 1050 described above with reference to FIG. 10 may be performed at each of a plurality of points in time 1401 to 1405 of the first temperature profile 1410 of FIG. 14. For example, the plurality of points in time 1401 to 1405 may include a point in time 1401 of a period in which the susceptor is preheated, a point in time 1402 when a temperature of the susceptor reaches a target temperature for preheating, a point in time 1403 of a period in which the temperature of the susceptor maintains the target temperature, a point in time 1404 of a period in which the temperature of the susceptor maintains a second temperature, and a point in time 1405 of a period in which the temperature of the susceptor maintains a third temperature. A plurality of points in time 1401 to 1405 has been described as an example of a plurality of points in time determined as target points in time, but the period and number at which each of the plurality of points in time is selected may vary depending on embodiments. The aerosol generating device may accurately control a temperature of the susceptor by continuously examining whether the susceptor has changed while generating aerosol based on the first temperature profile 1410.

According to an embodiment, when it is determined that the susceptor is changed, the aerosol generating device may control the signal applied to the coil of the heater based on the new control characteristic and temperature profile without stopping the heating operation of the aerosol generating article by obtaining the control characteristic of the changed susceptor as described above with reference to FIG. 12.

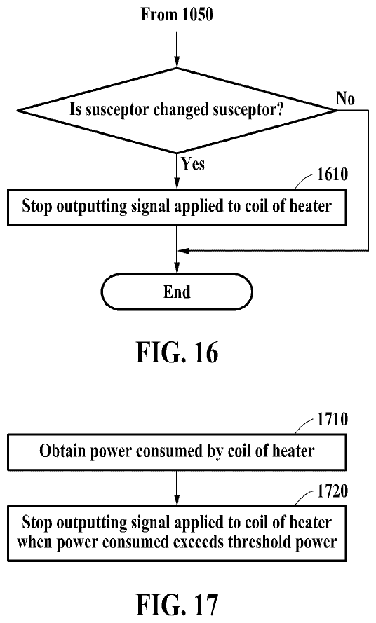

According to an embodiment, when it is determined that the susceptor is changed, the aerosol generating device may stop heating the aerosol generating article by stopping the output of the signal applied to the coil of the heater. A method of stopping the output of the signal applied to the coil of the heater is described in detail below with reference to FIG. 16.

In the above-described embodiment with reference to FIGS. 13 and 14, when an aerosol generating article is inserted, it is determined whether a susceptor is a changed susceptor by performing operations 1010 to 1050 described above with reference to FIG. 10 at a target point in time of the first temperature profile 1410 for heating the aerosol generating article. In another embodiment, when the aerosol generating article is not inserted, the aerosol generating device may control a signal applied to the coil of the heater based on a second temperature profile in a separate operation mode performed in a target state, and may determine whether the susceptor is a changed susceptor by performing operations 1010 to 1050 described above with reference to FIG. 10 at the target point in time of the second temperature profile. For example, the target state may be a state in which separation of the susceptor is detected in the aerosol generating device, and installation of the susceptor is detected after. For example, the target state may be a state in which a particular amount of time has passed since operations 1010 to 1050 described above with reference to FIG. 10 have been performed in the aerosol generating device. The second temperature profile may be a temperature profile in which a temperature of the susceptor is controlled to determine whether the susceptor is a changed susceptor while an aerosol generating article is not inserted. For example, the second temperature profile may be a temperature profile in which the susceptor is heated to maintain a target temperature, and the target temperature may be a temperature at which the electrical characteristics of each of the susceptors are differentiated while consuming less battery power of the aerosol generating device to heat the susceptors. For example, the target point in time may be a point in time at which a temperature of the susceptor is maintained at the target temperature in the second temperature profile.

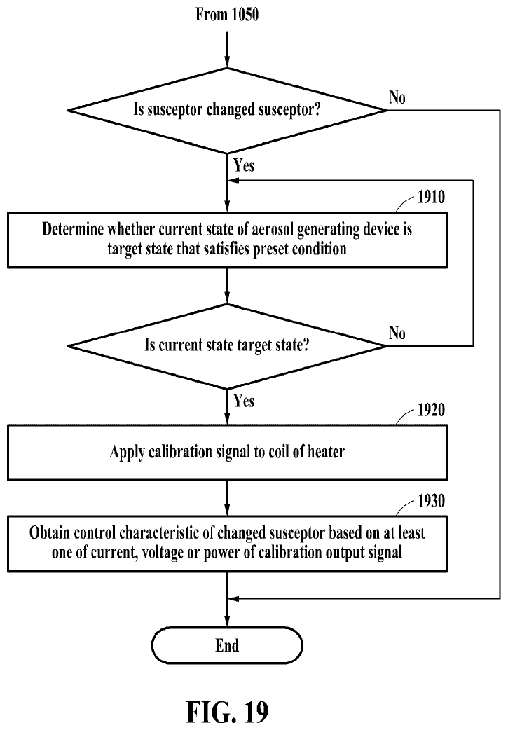

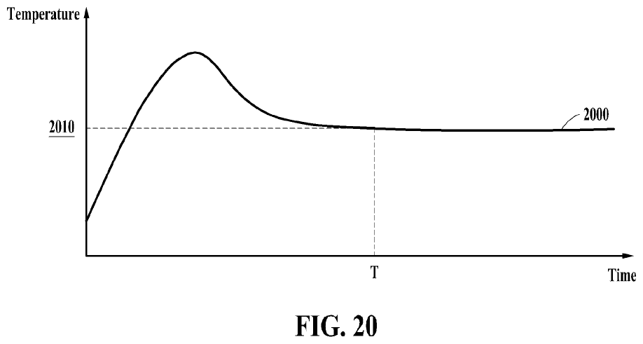

According to an embodiment, when it is determined that the susceptor is a changed susceptor by performing operations 1010 to 1050 described above with reference to FIG. 10 at a target point in time of the second temperature profile according to the above-described embodiment, the aerosol generating device may obtain the control characteristic of the changed susceptor through a separate, sequential operation (e.g., a user calibration). A signal applied to the coil of the heater may be controlled based on the control characteristic of the changed susceptor. A method of obtaining the control characteristic of the changed susceptor through a separate operation is described in detail with reference to FIGS. 19 and 20 below.

FIG. 15 is a diagram illustrating a signal applied to a coil of a heater based on a first temperature profile, according to an embodiment of the present disclosure.

To detect a change in the susceptor or to detect a temperature of the susceptor, a signal may be applied to the coil of the heater as described above with reference to FIG. 10. The greater a voltage of the signal applied to the coil of the heater, the greater a size of an eddy current induced in the susceptor may be, and the temperature of the susceptor may further increase due to the eddy current induced in the susceptor. The temperature of the susceptor may be controlled inaccurately due to an unintended increase in the temperature of the susceptor caused by an operation of detecting a change in the susceptor or an operation of detecting the temperature of the susceptor. Accordingly, the voltage of the signal applied to the coil of the heater may be controlled below a preset voltage so that the temperature of the susceptor does not increase through an operation of detecting a change in the susceptor or an operation of detecting the temperature of the susceptor.

According to an embodiment, the operation of applying a signal to the coil so that the temperature of the susceptor does not increase through an operation of detecting a change in the susceptor or an operation of detecting the temperature of the susceptor may be performed for a short period of time (e.g., several milliseconds).

Referring to FIG. 15, a signal applied to the coil of the heater in each unit period (e.g., a first period, a second period, and a third period) of a first temperature profile is illustrated. The aerosol generating device may perform an operation of detecting a change in the susceptor or an operation of detecting the temperature of the susceptor for each detection period of each unit period of the first temperature profile. For example, a length of each unit period of the first temperature profile may be 0.1 second. Each unit period may include a heating period (e.g., a first heating period, a second heating period, and a third heating period) and a detection period. In the heating period, a signal applied to the coil of the heater may be controlled so that the temperature of the susceptor follows the temperature of the first temperature profile. For example, in the first period in which the temperature of the susceptor increases, a signal having a first voltage 1503 may be applied to the coil, in the second period in which the temperature of the susceptor is maintained, a signal having a second voltage 1502 may be applied to the coil, and in the third period in which the temperature of the susceptor decreases, a signal having a third voltage 1501 may be applied. In the detection period, a signal having the second voltage 1502 that is lower than a preset voltage may be applied for a short period of time.

When a signal having a voltage lower than a preset voltage is applied to the coil of the heater for a short period of time in the operation of detecting a replacement of the susceptor or the operation of detecting the temperature of the susceptor, the temperature of the susceptor may be continuously monitored to follow the temperature profile and may be accurately controlled by preventing an additional temperature increase of the susceptor due to the detection operation.

FIG. 16 is a flowchart of a method of controlling a signal applied to a coil of a heater, according to an embodiment of the present disclosure.

According to an embodiment, the following operation 1610 may be performed by an aerosol generating device (e.g., the aerosol generating device 1 of FIGS. 1 to 3, the aerosol generating device 9 of FIGS. 4 to 8, or the aerosol generating device 900 of FIG. 9). For example, operation 1610 may be performed after operation 1050 described above with reference to FIG. 10 is performed. The aerosol generating device may include a controller including at least one processor and memory storing instructions executable by the controller.

In operation 1610, when the susceptor is a changed susceptor, the aerosol generating device may stop outputting a signal applied to the coil of the heater. When a change in the susceptor is detected during a user's smoking process, before obtaining a control characteristic of the changed susceptor through a separate operation, the aerosol generating device may stop outputting the signal applied to the coil of the heater to prevent inaccurate temperature control. Hereinafter, the separate operation to obtain the control characteristic of the changed susceptor may be referred to as a user calibration.

According to an embodiment, the aerosol generating device may provide an error notification to the user when it is determined that the susceptor is a changed susceptor and output a message requesting removal of an aerosol generating article. The aerosol generating device may perform a separate operation (e.g., a user calibration) to obtain the control characteristic of the changed susceptor after the aerosol generating article is removed.

According to an embodiment, the aerosol generating device may determine whether a current state is a target state satisfying a preset condition after operation 1610 is performed. For example, the target state may be at least one of a state in which an aerosol generating article is not inserted in the aerosol generating device, a state in which a body temperature of the aerosol generating device is within a target temperature range, or a state in which a user has executed a user calibration operation. For example, the target temperature range may be a temperature range corresponding to room temperature. The target temperature range may be set differently depending on an environment in which the aerosol generating device is generally used. For example, the target temperature range may be set differently depending on a region (e.g., country) and time (e.g., season) in which the aerosol generating device is used.

When the current state is the target state, the aerosol generating device may obtain the control characteristic of the changed susceptor through a separate operation (e.g., a user calibration). The signal applied to the coil of the heater may be controlled based on the control characteristic of the changed susceptor. The method of obtaining the control characteristic of the changed susceptor through a separate operation is described in detail with reference to FIGS. 19 and 20 below.

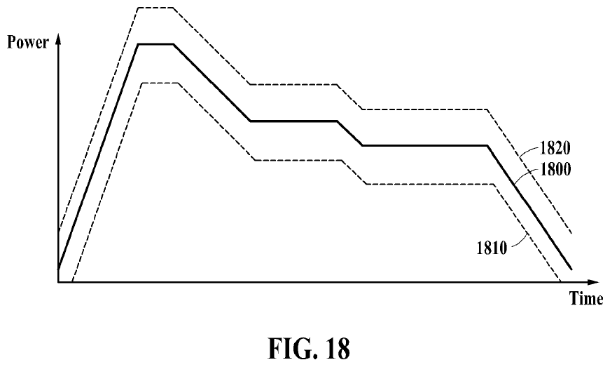

FIG. 17 is a flowchart of a method of controlling a signal applied to a coil of a heater, according to an embodiment of the present disclosure, and FIG. 18 is a diagram illustrating power and threshold power consumed by a coil of a heater, according to an embodiment of the present disclosure.

According to an embodiment, the following operations 1710 and 1720 may be performed by an aerosol generating device (e.g., the aerosol generating device 1 of FIGS. 1 to 3, the aerosol generating device 9 of FIGS. 4 to 8, or the aerosol generating device 900 of FIG. 9). For example, operations 1710 and 1720 may be performed independently and in parallel with operation 1310 described above with reference to FIG. 13. The aerosol generating device may include a controller including at least one processor and memory storing instructions executable by the controller.

In operation 1710, the aerosol generating device may obtain power consumed by the coil of the heater. Since the power consumed by the coil of the heater includes power that is transmitted to the susceptor to generate induction heating, the aerosol generating device may indirectly monitor an intensity of the induction heating generated in the susceptor through the power consumed by the coil of the heater.

In operation 1720, the aerosol generating device may stop outputting a signal applied to the coil of the heater when the power consumed by the coil of the heater exceeds a threshold power. When the power consumed by the coil of the heater is abnormally large, it may be determined that the susceptor is overheated. The aerosol generating device may protect the aerosol generating device by stopping the heating operation of the susceptor when it is determined that the susceptor is overheated.

According to an embodiment, when the power consumed by the coil of the heater exceeds an upper threshold power 1820 or falls below a lower threshold power 1810, the aerosol generating device may determine the operation of the aerosol generating device as an abnormal operation and stop outputting the signal applied to the coil of the heater. For example, the upper threshold power 1820 may be determined by multiplying, a power 1800 consumed by the coil of the heater when a temperature of a reference susceptor follows the first temperature profile, by a first multiple (e.g., 120%), when the reference susceptor is coupled to the aerosol generating device, and the lower threshold power 1810 may be determined by multiplying, the power 1800 consumed by the coil of the heater when the temperature of the reference susceptor follows the first temperature profile, by a second multiple (e.g., 80%), when the reference susceptor is coupled to the aerosol generating device.

According to an embodiment, operations 1710 and 1720 may be performed when a change in the susceptor is detected during the operation of the aerosol generating device heating the aerosol generating article, and a signal applied to the coil of the heater is controlled based on the new control characteristic. When an error occurs in the process of the aerosol generating device detecting a change in the susceptor and obtaining the control characteristic of the changed susceptor, resulting in inaccurate control of the temperature of the susceptor, the power consumed by the coil of the heater may be monitored to prevent inaccurate control of the temperature of the susceptor.

FIG. 19 is a flowchart of a method of obtaining a control characteristic of a susceptor, according to an embodiment of the present disclosure, and FIG. 20 is a diagram illustrating a temperature change of a susceptor when a calibration signal is applied, according to an embodiment of the present disclosure.

According to an embodiment, the following operations 1910 to 1940 may be performed by an aerosol generating device (e.g., the aerosol generating device 1 of FIGS. 1 to 3, the aerosol generating device 9 of FIGS. 4 to 8, or the aerosol generating device 900 of FIG. 9). For example, operations 1910 to 1940 may be performed after operation 1050 described above with reference to FIG. 10 is performed. The aerosol generating device may include a controller including at least one processor and memory storing instructions executable by the controller.

In operation 1910, when it is determined that the susceptor of the aerosol generating device is a changed susceptor, the aerosol generating device may determine whether a current state of the aerosol generating device is a target state that satisfies a preset condition. For example, the target state may be a state in which an aerosol generating article is not inserted into the aerosol generating device. For example, the target state may be a state in which a body temperature of the aerosol generating device is within a target temperature range. For example, the target state may be a state in which a user has executed a user calibration operation. For example, the target state may be a state in which a change in the susceptor is detected during a heating operation of the aerosol generating article, causing the heating operation of the aerosol generating article to be stopped, and the user has removed the aerosol generating article from the aerosol generating device in response to a notification from the aerosol generating device, as described with reference to FIG. 16.

In operation 1920, when the current state is the target state, the aerosol generating device may apply a calibration signal to the coil of the heater. The calibration signal may be a signal of a power profile in which the power applied to the coil of the heater is controlled to obtain the control characteristic of the susceptor by the aerosol generating device. For example, when a calibration signal to obtain the control characteristic of the susceptor is applied to the coil of the heater, the susceptor of the aerosol generating device may be controlled to be heated to a peak temperature as shown in a temperature change trajectory 2000 of FIG. 20 and then maintained at a first temperature 2010 below the peak temperature. For example, the first temperature 2010 may be a temperature within a range of 310° C. to 370° C. Preferably, the first temperature 2010 may be 335° C. or 355° C.

Even when the natural frequencies of the susceptors are different from each other, when the natural frequencies are included within a preset frequency range, each of the convergence temperatures of the susceptors indicated by the calibration signal may correspond to the first temperature 2010. However, even when each of the convergence temperatures of the susceptors corresponds to the first temperature 2010, the magnitude of the calibration output signals appearing at the output end of the coil of the heater may be different from each other. The control characteristic of the changed susceptor may be determined based on the magnitude of the calibration output signal.

According to an embodiment, the aerosol generating device may include a temperature sensor configured to obtain a body temperature of the aerosol generating device, and when the body temperature of the aerosol generating device is not within a target temperature range, the aerosol generating device may not apply a calibration signal to the coil of the heater for obtaining the control characteristic of the susceptor. For example, the target temperature range may be 20° C. to 25° C. For example, when the body temperature of the aerosol generating device excessively increases or decreases due to an external environment, the aerosol generator may not apply the calibration signal to the coil of the heater and may transmit an error notification to the user. In this embodiment, when the body temperature of the aerosol generating device increases or decreases excessively, the control characteristic of the susceptor may be inaccurately obtained, so the operation of the aerosol generating device may be controlled to obtain the control characteristic of the changed susceptor after the body temperature returns to a normal range.

In operation 1930, the aerosol generating device may obtain the control characteristic of the changed susceptor based on at least one of a current, voltage or power of the calibration output signal appearing at the output end of the coil of the heater. For example, the control characteristic of the changed susceptor may be obtained based on at least one of a current, voltage, or power of the calibration output signal after a point in time T at which the temperature of the susceptor is maintained at the first temperature 2010 in the temperature change trajectory 2000 of the susceptor by the calibration signal.

In operation 1940, the aerosol generating device may control the signal applied to the coil of the heater based on the control characteristic of the changed susceptor. By varying a frequency, size, duty ratio, or the like of the reference signal based on the control characteristic of the changed susceptor, the changed susceptor may be controlled to follow a preset temperature profile. Accordingly, the aerosol generating device may accurately heat an aerosol generating article that is subsequently inserted based on the obtained control characteristic of the susceptor.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and/or equivalents of the claims are within the scope of the following claims.

What is claimed is:

1. A method of determining a susceptor change, performed by an aerosol generating device, the method comprising:
applying a first signal to a coil of a heater so that an alternating magnetic field having a first frequency is generated;
determining a first value of an electrical characteristic of a susceptor indicated by the first signal;
applying a second signal to the coil of the heater so that an alternating magnetic field having a second frequency is generated;
determining a second value of an electrical characteristic of the susceptor indicated by the second signal; and
determining whether the susceptor is a changed susceptor based on the first value and the second value.

2. The method of claim 1, wherein the determining of the first value of the electrical characteristic of the susceptor comprises determining the first value based on at least one of a current, a voltage, or power of a first output signal appearing at an output end of the coil of the heater, and
the determining of the second value of the electrical characteristic of the susceptor comprises determining the second value based on at least one of a current, a voltage, or power of a second output signal appearing at the output end of the coil of the heater.

3. The method of claim 1, further comprising,
in response to it being determined that the susceptor is the changed susceptor, obtaining a control characteristic of the changed susceptor based on the first value and the second value,
wherein a signal applied to the coil of the heater is controlled based on the control characteristic.

4. The method of claim 1, further comprising,
in response to an aerosol generating article being inserted into the aerosol generating device, controlling a signal applied to the coil of the heater based on a first temperature profile,
wherein, in response to it being determined that a current point in time corresponds to a first point in time of the first temperature profile,
the first signal is applied to the coil of the heater so that the alternating magnetic field having the first frequency is generated, and
the second signal is applied to the coil of the heater so that the alternating magnetic field having the second frequency is generated.

5. The method of claim 4, further comprising:
in response to it being determined that a current point in time corresponds to a second point in time of the first temperature profile:
applying a third signal to the coil of the heater so that the alternating magnetic field having the first frequency is generated;
determining a third value of an electrical characteristic of the susceptor indicated by the third signal;
applying a fourth signal to the coil of the heater so that the alternating magnetic field having the second frequency is generated;
determining a fourth value of an electrical characteristic of the susceptor indicated by the fourth signal; and
determining whether the susceptor is a changed susceptor based on the third value and the fourth value.

6. The method of claim 4, wherein each of a voltage of the first signal and a voltage of the second signal is less than or equal to a preset voltage.

7. The method of claim 4, further comprising:
in response to it being determined that the susceptor is the changed susceptor, stopping an output of the signal applied to the coil of the heater based on the first temperature profile.

8. The method of claim 4, further comprising:
in response to it being determined that the susceptor is a changed susceptor, obtaining the control characteristic of the changed susceptor based on the first value and the second value; and
controlling the signal applied to the coil of the heater based on the control characteristic and the first temperature profile.

9. The method of claim 4, further comprising:
obtaining power consumed by the coil of the heater; and
in response to the power consumed exceeding a threshold power, stopping the output of the signal applied to the coil of the heater.

10. The method of claim 1, further comprising:
in response to it being determined that the susceptor is a changed susceptor, determining whether a current state of the aerosol generating device is a target state satisfying a preset condition;
in response to the current state being the target state, applying a calibration signal to the coil of the heater; and
obtaining a control characteristic of the changed susceptor based on at least one of a current, a voltage, or power of a calibration output signal appearing at the output end of the coil of the heater,
wherein a signal applied to the coil of the heater is controlled based on the control characteristic.

11. A non-transitory computer-readable storage medium storing instructions that are executable by a processor to perform the method of claim 1.

12. An aerosol generating device, comprising:
a coil of a heater, the coil configured to generate an alternating magnetic field; and
a controller configured to control the aerosol generating device,
wherein the controller is further configured to:
apply a first signal to the coil of the heater so that an alternating magnetic field having a first frequency is generated;
determine a first value of an electrical characteristic of a susceptor indicated by the first signal;
apply a second signal to the coil of the heater so that an alternating magnetic field having a second frequency is generated;
determine a second value of an electrical characteristic of the susceptor indicated by the second signal; and
determine whether the susceptor is a changed susceptor based on the first value and the second value.

13. The aerosol generating device of claim 12, further comprising,
an electrical sensor configured to obtain at least one of a current, a voltage, or power at an output end of the coil of the heater,
wherein the determining of the first value of the electrical characteristic of the susceptor comprises determining the first value based on at least one of a current, a voltage, or power of a first output signal appearing at an output end of the coil of the heater, and
the determining of the second value of the electrical characteristic of the susceptor comprises determining the second value based on at least one of a current, a voltage, or power of a second output signal appearing at the output end of the coil of the heater.

14. The aerosol generating device of claim 12, wherein the controller is further configured to, in response to an aerosol generating article being inserted into the aerosol generating device, control a signal applied to the coil of the heater based on a first temperature profile, and wherein
in response to it being determined that a current point in time corresponds to a first point in time of the first temperature profile,
the first signal is applied to the coil of the heater so that the alternating magnetic field having the first frequency is generated, and
the second signal is applied to the coil of the heater so that the alternating magnetic field having the second frequency is generated.

15. The aerosol generating device of claim 12, wherein the controller is further configured to:
in response to it being determined that the susceptor is the changed susceptor, determine whether a current state of the aerosol generating device is a target state satisfying a preset condition;
in response to the current state being the target state, apply a calibration signal to the coil of the heater; and
obtain a control characteristic of the changed susceptor based on at least one of a current, a voltage, or power of a calibration output signal appearing at the output end of the coil of the heater; and
control a signal applied to the coil of the heater based on the control characteristic.
